(19) United States
(12) Patent Application Publication
(10) Pub. No.: US 2023/0355352 A1
(43) Pub. Date: Nov. 9, 2023

(54) ARTICLES, METHODS AND COMPOSITIONS COMPRISING POLYMERIZABLE DICARBONYL POLYMERS

(71) Applicant: 3M INNOVATIVE PROPERTIES COMPANY, St. Paul, MN (US)

(72) Inventors: Deborah K. Schneiderman, St. Paul, MN (US); Saswata Chakraborty, Sunnyvale, CA (US); David S. Hays, Woodbury, MN (US)

(21) Appl. No.: 18/246,103

(22) PCT Filed: Nov. 16, 2021
(86) PCT No.: PCT/IB2021/060619

§ 371 Date: Mar. 21, 2023

Related U.S. Application Data
(60) Provisional application No. 63/116,347, filed on Nov. 20, 2020.

(51) Int. Cl. A61C 7/08; C08F 290/06; B29C 64/129

(52) U.S. Cl. CPC A61C 7/08; C08F 290/061; C08F 290/062; B29C 64/129; C08F 2810/40; B33Y 10/00

(57) ABSTRACT

An orthodontic article is described comprising the reaction product of free-radically polymerizable resin comprising at least one dicarbonyl polymer comprising polymerized units of oxamate, oxalate, or a combination thereof and at least two free-radically polymerizable groups. Also described are dicarbonyl polymers, methods of making dicarbonyl polymers and method of use for the described polymerizable resin are also described.

### SUMMARY

In one embodiment, an orthodontic article is described comprising the reaction product of free-radically polymerizable resin comprising at least one dicarbonyl polymer comprising polymerized units of oxamate, oxalate, or a combination thereof and at least two free-radically polymerizable groups.

In another embodiment, dicarbonyl polymers are described comprising at least two terminal free-radically polymerizable groups and repeat units having the formula:

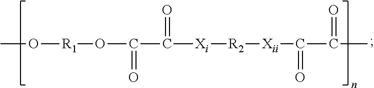

wherein
each —O—R₁—O— is independently a polymerized unit of a polymeric polyol;
Xi and Xii are independently O or NR³ wherein R³ is H or an organic group;
each R₂ is independently an organic group; and
n is at least 1, 2, 3, 4, 5, 6, 7, 8, 9, or 10.

Methods of making dicarbonyl polymers are also described.

In another embodiment, a polymerizable composition is described comprising:
at least one dicarbonyl polymer comprising polymerized units of oxamate, oxalate, or a
combination thereof and at least two free-radically polymerizable groups; and
at least one other free-radically polymerizable component.

Also described is a polymerizable composition for use for 3D printing comprising at least one dicarbonyl polymer comprising polymerized units of oxamate, oxalate, or a combination thereof and at least two free-radically polymerizable groups.

In another embodiment, a method of making an article comprising:
a) providing a polymerizable composition as described herein;
b) selectively curing the polymerizable composition to form an article; and
c) optionally curing unpolymerized dicarbonyl polymer and/or other free-radically polymerizable components remaining after step (b).

In another embodiments, a non-transitory machine-readable medium comprising data representing a three-dimensional model of an article, when accessed by one or more processors interfacing with a 3D printer, causes the 3D printer to create an article comprising a reaction product of a polymerizable composition described herein.

Also described are methods and systems concerning digital objects and 3D printing.

### BRIEF DESCRIPTION OF THE DRAWINGS

FIG. 1 is a flowchart of a process for building an article using the photopolymerizable compositions disclosed herein.

FIG. 2 is a generalized schematic of a stereolithography apparatus.

FIG. 3 is an isometric view of an embodied printed (e.g. clear) orthodontic tray aligner.

FIG. 4 is a flowchart of a process for manufacturing a printed orthodontic appliance according to the present disclosure.

FIG. 5 is a generalized schematic of an apparatus in which radiation is directed through a container.

FIG. 6 is a block diagram of a generalized system 600 for additive manufacturing of an article.

FIG. 7 is a block diagram of a generalized manufacturing process for an article.

FIG. 8 is a high-level flow chart of an exemplary article manufacturing process.

FIG. 9 is a high-level flow chart of an exemplary article additive manufacturing process.

### DETAILED DESCRIPTION OF ILLUSTRATIVE EMBODIMENTS

The polymerizable compositions described herein comprise at least one polymer comprising free-radically polymerizable groups. The polymer further comprises polymerized units comprising dicarbonyl moieties —C(═O)C(═O)—.

In some embodiments, the dicarbonyl polymer comprises polymerized units comprising oxamate moieties. Oxamate moieties have the formula —NC(═O)C(═O)O—. Polymers comprising such polymerized units are typically characterized as polyoxamates.

In other embodiments, the dicarbonyl polymer comprises polymerized units comprising oxalate moieties. Oxalate moieties have the formula —OC(═O)C(═O)O—. Polymers comprising such polymerized units are typically characterized as polyoxalates.

Thus, the dicarbonyl polymer comprises moieties having the formula

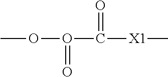

wherein Xᵢ is O or NR³ wherein R³ is H or an organic group. The organic group is typically C1-C4 alkyl. R³ can be other organic group as will subsequently be described.

In some embodiments, the dicarbonyl polymer may comprise both polyoxamate and polyoxalate moieties. The dicarbonyl polymer typically comprises at least 3, 4, 5, 6, 7, 8, 9, or 10 polymerized units of oxamate, oxalate, or a combination thereof.

The dicarbonyl polymer is prepared from one or more polymeric polyols (e.g. diols). Thus, the dicarbonyl polymer comprises polymerized units of one or more polymeric polyols. Typical polymeric polyols include polycarbonate diol, polyester diol, polyether (i.e., polyalkylene oxide) diol, and polyolefin (i.e., polyalkylene or polyalkene) diol. Thus, R₁ is polycarbonate, polyester, polyether (i.e., polyalkylene oxide), polyolefin (i.e., polyalkylene or polyalkene), or a combination thereof. Various polymeric polyols (e.g. diols) are commercially available. Polymeric polyols can be prepared by methods known in the art.

In typical embodiments, the dicarbonyl polymer comprises at least two terminal free-radically polymerizable groups and repeat units having the following Formula I:

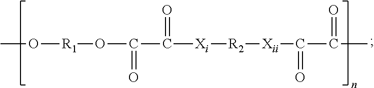

wherein
each —O—R₁—O— is independently a polymerized unit of a polymeric polyol;
Xi and Xii are independently O or NR³ wherein R³ is H or an organic group;
each R₂ is independently an organic group; and
n is at least 1, 2, 3, 4, 5, 6, 7, 8, 9, or 10.

The polymeric polyol (e.g. diol) typically has a number average molecular weight (Mn) of at least 325, 350, 400, 450, 500, 550, 600, 650, 700, 750, 1000, 1250, 1500, 1750, 2000, 2250, 2500, 2750, or 3000 g/mole. The molecular weight of the polymeric polyol (e.g. diol) is typically no greater than 10,000; 9,000; 8,000; 7,000; 6,000; 5000; 4000; or 3000 g/mole. In some embodiments, the polymeric polyol (e.g. diol) comprises two or more polyols (e.g. diols) wherein the number average molecular weight is a weight average of the two or more polyols (e.g. diols). For example, two polymeric diols may be present at a molar ratio of 1:2, wherein a first polymeric diol has a Mn of about 500 g/mol and a second polymeric diol has a Mn of about 1,500 g/mol, resulting in a weighted average Mn of 1,167 g/mol. The molecular weight of the diol can be determined from the —OH value, as can be determined by titration. The molecular weight and/or equivalent weight of commercially available polymeric polyols (e.g. diols) is reported by the supplier.

The dicarbonyl polymer can be prepared from a single polymeric polyol (e.g. diol) or a combination of different polymeric polyols (e.g. diols). The dicarbonyl polymer typically comprises at least 1, 2, 3, 4, or 5 polymerized units of polymeric polyol(s) (e.g. diol(s)). The number of polymerized repeat units of polymeric polyol(s) (e.g. diol(s)) of the dicarbonyl polymer is typically no greater than 25, 20, 15, or 10.

In some embodiments, the dicarbonyl is prepared from a polycarbonate diol. Polycarbonate diols comprise aliphatic and/or aromatic organic moieties (R), bonded with carbonate groups (—ROC(═O)OR—) between terminal —OH groups. The carbonate group is —OC(═O)O—. Polycarbonate diol can be manufactured by various methods, as known in the art. Polycarbonate diols are typically manufactured by condensation polymerization of a diol with carbonyl chloride (phosgene) or polymerization of a diol with an aliphatic or aromatic carbonate.

Suitable diols include for example ethylene glycol, 1,3-propanediol, 1,5-pentanediol, 1,4-butanediol, 1,6-hexanediol 1,7-heptanediol, 1,8-octanediol, 1,9-nonanediol, 1,10-dodecanediol, 1,11-undecanediol and 1,12-dodecanediol; diols having a side chain such as 2-methyl-1,8-octanediol, 2-ethyl-1,6-hexanediol, 2-methyl-1,3-propanediol, 3-methyl-1,5-pentanediol, 2,4-dimethyl-1,5-pentanediol, 2,4-diethyl-1,5-pentanediol, 2-butyl-2-ethyl-1,3-propanediol and 2,2-dimethyl-1,3-propanediol; and cyclic diols such as 1,4-cyclohexane dimethanol and 2-bis(4-hydroxycyclohexyl)-propane. The polycarbonate may also be manufactured from small concentrations of polyol compounds having 3 or more hydroxyl groups such as trimethylolethane, trimethylolpropane, hexanetriol, and pentaerythritol. Such polyol compounds may be present in amounts from 0.01 to 1, 2, 3, 4, or 5% by weight, based on the total amount of polyol. The amount is sufficiently small to prevent gelation.

Carbonates useful for manufacturing polycarbonate diol include aliphatic carbonates such as dimethyl carbonate, diethyl carbonate, dipropyl carbonate and dibutyl carbonate; aromatic carbonates such as diphenyl carbonate; and alkylene carbonates such as ethylene carbonate, trimethylene carbonate, 1,2-propylene carbonate, 1,2-butylene carbonate, 1,3-butylene carbonate and 1,2-pentylene carbonate. Typically the carbonate used in the manufacture of the diol is dimethyl carbonate, diethyl carbonate, diphenyl carbonate, dibutyl carbonate or ethylene carbonate. A catalyst, as known in the art, may be utilized during the condensation polymerization.

The polycarbonate diol is typically of the following formula:

H(O—R₂—O—C(═O))ₘ—O—R₃—OH

When the polycarbonate diol is prepared from two different diols, the polycarbonate diol may be represented by the formula:

H[O—R₂—O—C(═O)]ₘ₁[O—R₄—O—C(═O)]ₘ₂—R₃—OH

In each of these formulas R₂ and R₄ are residues of diols and R₃ is a residue of a coreactant such as a carbonate or an end-capping unit.

R₂, R₃, and R₄ are independently C1 to C12 organic groups. The organic groups can comprise aliphatic moieties, aromatic moieties, or a combination thereof. In some embodiments, R₂, R₃, and R₄ are independently alkylene groups having at least 4, 5, or 6 and no greater than 8, 10 or 12 carbon atoms. The alkylene group may be a straight chain, branched, or cycloaliphatic, or a combination thereof.

The number of repeat groups represented by m or the sum of m1 and m2 is at least 2, 3, 4, 5, or 6 and typically no greater than 12. In some embodiments, m or the sum of m1 and m2 is no greater than 11, 10, 9, or 8.

One representative polycarbonate diol prepared from 3-methyl-1,5-pentanediol (MPD) and hexane diol (HD) is available from Kuraray Co. Ltd., Tokyo, Japan as the trade designation “KURARAY POLYOL C2050R”.

In some embodiments, the dicarbonyl polymer is prepared from a polyester diol. Polyester diols comprise aliphatic and/or aromatic organic moieties (R), bonded with ester groups, —RC(O)OR—, between terminal —OH groups.

Polyester diols are typically manufactured by polycondensation of a diacid, ring opening of a lactide or caprolactone, or by reaction of a diacid with a diol.

Suitable diacids include C2-C24 aliphatic diacids such as in the case of oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, tridecanedioic acid, hexanedecanedioic acid, linoleic acid; and dimer acids thereof having up to 40 carbon atoms.

Suitable C6-C12 aromatic acids includes for example terephthalic acid and 2,4-naphthalenedicarboxylic acid.

Suitable diols are the same as previously described.

When the polyester diol is prepared from a single diol and a single diacid, the polyester diol typically has the formula:

H[O—R₂—O—C(═O)—R₅—C(═O)]ₘ₃—O—R₃—OH

In this formula R₂ is independently a residue of a diol, R₅ is a residue of a diacid, and R₃ is an end-capping unit. The R₂ and R₃ can be the same as previously described for the polycarbonate polyol. The number of repeat units, m3, is typically at least 2, 3, or 4 ranging up to 25, 30, 35, 40, 45, or 50. In some embodiments, m3 is in the same range as m as previously described for the polycarbonate diol.

R₅ can comprise an aliphatic or aromatic organic group having up to 40 carbon atoms. In some embodiments, R₅ is no greater than 24 or 12 carbon atoms. In some embodiments R₅ can be the same as R₁.

In some embodiments, the diacid and diol (or in other words the R₂ and R₅ groups of the polyester) comprise at least 4, 5, or 6 and no greater than 8, 10, or 12 carbon atoms. One representative polyester diol prepared from 3-methyl-1,5-pentanediol (MPD) and adipate is available from Kuraray Co. Ltd., Tokyo, Japan as the trade designation “KURARAY POLYOL P-2010”.

When the polyester is prepared by ring opening of a caprolactone, the polyester may have the formula

H[—O—R₆—C(═O)]ₘ₄—O—R₂—O—[C(═O)—R₆—O]ₘ₅—H;

In this embodiment, R₆ is a ring opened caprolactone group (i.e. a C₅ alkylene group) and R₂ is a residue of a diol as previously described. The number of repeat units m4 and m5 are typically independently at least 4, 5 or 6 and no greater than 25, 20, or 15.

In some embodiments, the dicarbonyl is prepared from a polyether diol. Polyether diols comprise a repeating —OR₇— group between terminal —OH groups.

Polyether diols typically have the formula:

H[O—R₇]ₘ₆OH;

In typical embodiments, the polyether may be characterized as polyalkylene oxide wherein each R₇ is independently a straight chain, branched, or cyclic alkylene group of 2 to 6 carbon atoms. In some embodiments, R₇ is ethylene and/or propylene (i.e. 2-3 carbon atoms). In other embodiments, R₇ has at least 3 or 4 carbon atoms. The number of repeat units, m6, is typically at least 5, 6, 7, 8, 9, or 10 ranging up to 20, 30, 40, 50 60, 70, or 80 or greater to obtain the molecular weight (Mn) described above. One representative polyether diol is poly(tetrahydrofuran) diol.

In some embodiments, such as when the dicarbonyl polymer is utilized to prepare an orthodontic (e.g. aligner) article or other article comes in contact with water or an aqueous fluid during normal use, the wt. % of polyalkylene oxide (especially polyethylene oxide) moieties is no greater than 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 wt. % of the polymerizable resin.

In some embodiments, the dicarbonyl polymer is prepared from a polyolefin diol. Polyolefin diols comprise a saturated or unsaturated hydrocarbon group between terminal —OH groups.

Polyolefin diols typically have the formula:

HO[R₈]ₘ₆OH;

In typical embodiments, each R₈ is independently selected from straight chain, branched, or cyclic-containing alkene or alkylene group of 2 to 12 carbon atoms. In some embodiments, R₈ is ethylene and/or propylene (i.e. 2-3 carbon atoms). In other embodiments, R₈ has at least 3 or 4 carbon atoms. In number of repeat units, m6 can be the same as previously described. One representative polyolefin diol is poly(butadiene) diol. The number of repeat units, m6, is the same as previously described.

The dicarbonyl polymers can be prepared by any suitable method.

In some embodiments, the dicarbonyl is prepared by (e.g. first) reacting a polymeric diol as previously described with an oxylamino or oxalate compound comprising haloalkyl (e.g. fluoride, chloride) end groups; and reacting the haloalkyl end groups with a coreactant further comprising a free-radically polymerizable (e.g. (meth)acryl) group. Suitable coreactants compounds further comprise a hydroxy group, isocyanate group, or a halide (e.g. chloride) and a free radically polymerizable group. In some embodiments, the method further comprises reacting the haloalkyl end groups with a diol compound prior to reaction with the coreactant further comprising at least one free-radically polymerizable as depicted in Example 16.

One representative synthesis of reacting a polymeric diol (e.g. polybutene diol) with excess oxylamino compound (e.g. bis(2,2,2-trifluoroethyl) 2,2′-(ethane-1,2-diylbis(azanediyl))bis(2-oxoacetate)) followed by reaction with a hydroxyl functional free radically polymerizable compound is depicted as follows:

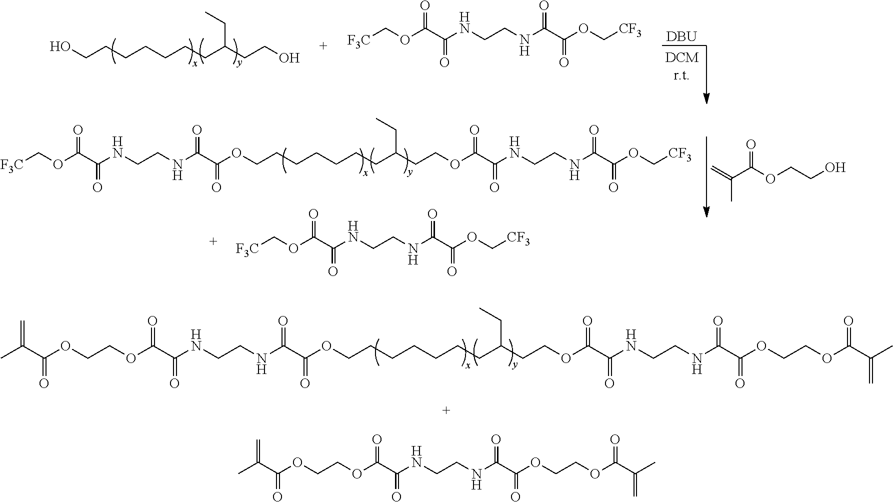

Another representative synthesis of reacting a polymeric diol (e.g. polyether diol) with excess oxylamino compound (e.g. bis(2,2,2-trifluoroethyl) 2,2′-(ethane-1,2-diylbis(azanediyl))bis(2-oxoacetate)) followed by reaction with an isocyante functional free radically polymerizable compound is depicted as follows:

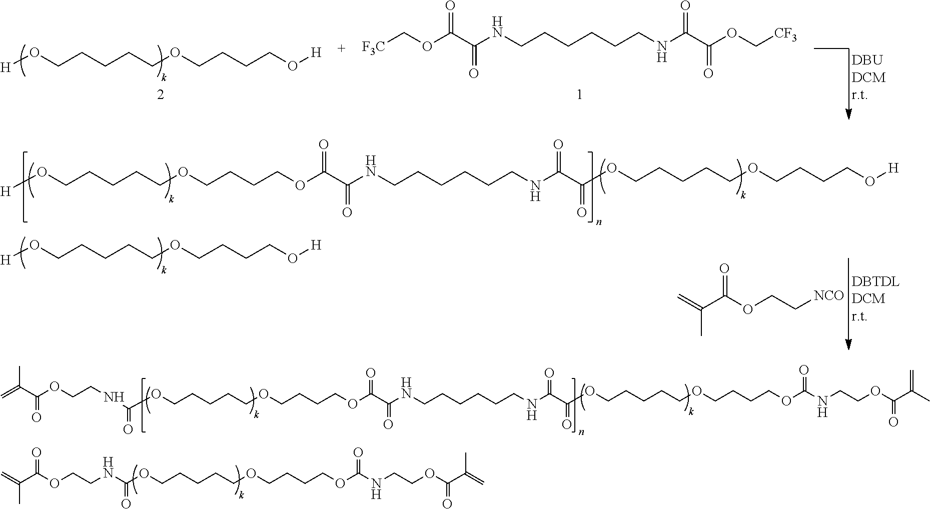

Other syntheses are depicted in the forthcoming examples.

The oxylamino compound typically has the following formula:

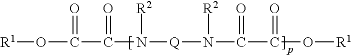

wherein each R¹ group is independently an alkyl, haloalkyl, aralkyl, substituted aralkyl, alkenyl, aryl, substituted aryl, or imino of the formula N═CR⁴R⁵. Each R⁴ is hydrogen, alkyl, aralkyl, substituted aralkyl, aryl, or substituted aryl. Each R⁵ is an alkyl, aralkyl, substituted aralkyl, aryl, or substituted aryl. Each R² is independently hydrogen, alkyl, aralkyl, aryl, or part of a heterocyclic group that includes Q and the nitrogen to which R² is attached (the nitrogen is the heteroatom of the heterocyclic group). It is appreciated that Q of the oxylamino compound also defines R₂ of Formulas I, II, and III. It is also appreciated that R² of NR² of the oxylamino compound also defines R³ of NR³ of Formulas I, II, and III.

Group Q is (a) an alkylene, (b) arylene, (c) a carbonylamino group linking a first group to a second group, wherein the first group and the second group are each independently an alkylene, arylene, or a combination thereof, (d) part of a heterocyclic group that includes R² and the nitrogen to which R² is attached, or (e) a combination thereof. The variable p is an integer equal to at least 1.

Suitable alkyl and haloalkyl groups for R¹ often have 1 to 10, 1 to 6, or 1 to 4 carbon atoms. Although tertiary alkyl (e.g., tert-butyl) and tertiary haloalkyl groups can be used, a primary or secondary carbon atom is often attached directly (i.e., bonded) to the adjacent oxy group. Exemplary alkyl groups include methyl, ethyl, n-propyl, iso-propyl, n-butyl, and iso-butyl. Exemplary haloalkyl groups include chloroalkyl groups and fluoroalkyl groups in which some, but not all, of the hydrogen atoms on the corresponding alkyl group are replaced with halo atoms. For example, the chloroalkyl or fluoroalkyl groups can be 2-chloroethyl, 2,2,2-trichloroethyl, 3-chloropropyl, 4-chlorobutyl, fluoromethyl, 2-fluoroethyl, 2,2-difluoroethyl, 2,2,2-trifluoroethyl, 1-(trifluoromethyl)-2,2,2-trifluorethyl, 3-fluoropropyl, 4-fluorobutyl, and the like.

Suitable alkenyl groups for R¹ often have 2 to 10, 2 to 8, 2 to 6, or 2 to 4 carbon atoms. Exemplary alkenyl groups include ethenyl, propenyl, butenyl, and pentenyl.

Suitable aryl groups for R¹ include those having 6 to 12 carbon atoms such as, for example, phenyl. The aryl can be unsubstituted or substituted with an alkyl (e.g., an alkyl having 1 to 4 carbon atoms such as methyl, ethyl, or n-propyl), an alkoxy (e.g., an alkoxy having 1 to 4 carbon atoms such as methoxy, ethoxy, or propoxy), halo (e.g., chloro, bromo, or fluoro), a haloalkyl (e.g., a haloalkyl having 1 to 4 carbon atoms such as trifluoromethyl), or alkoxycarbonyl (e.g., an alkoxycarbonyl having 2 to 5 carbon atoms such as methoxycarbonyl, ethoxycarbonyl, or propoxycarbonyl).

Suitable aralkyl groups for R¹ of the oxylamino compound include those having an alkyl group with 1 to 10 carbon atoms and an aryl group with 6 to 12 carbon atoms. For example, the aralkyl can be an alkyl having 1 to 10 carbon atoms or 1 to 4 carbon atoms substituted with phenyl. The aryl portion of the aralkyl can be unsubstituted or substituted with an alkyl (e.g., an alkyl having 1 to 4 carbon atoms such as methyl, ethyl, or n-propyl), an alkoxy (e.g., an alkoxy having 1 to 4 carbon atoms such as methoxy, ethoxy, or propoxy), halo (e.g., chloro, bromo, or fluoro), a haloalkyl (e.g., a haloalkyl having 1 to 4 carbon atoms such as trifluoromethyl), or alkoxycarbonyl (e.g., an alkoxycarbonyl having 2 to 5 carbon atoms such as methoxycarbonyl, ethoxycarbonyl, or propoxycarbonyl).

Suitable imino groups for R¹ are monovalent groups of formula —N═CR⁴R⁵. Suitable alkyl groups for either R⁴ or R⁵ can be linear or branched and typically contain 1 to 10 carbon atoms, 1 to 8 carbon atoms, 1 to 6 carbon atoms, or 1 to 4 carbon atoms. Suitable aryl, substituted aryl, aralkyl, and substituted aralkyl groups for R⁴ or R⁵ are the same as those describe above for R¹.

Each R² group of the oxylamino compound independently can be hydrogen, alkyl, aralkyl, aryl, or part of a heterocyclic group that includes Q and the nitrogen to which R² is attached. Suitable alkyl groups can be linear or branched and typically contain 1 to 10 carbon atoms, 1 to 8 carbon atoms, 1 to 6 carbon atoms, or 1 to 4 carbon atoms. Suitable aryl groups typically include those having 6 to 12 carbon atoms. The aryl group is often phenyl. Suitable aralkyl groups include those having an alkyl group with 1 to 10 carbon atoms substituted with an aryl group having 6 to 12 carbon atoms. Exemplary aralkyl groups often include an alkyl having 1 to 10 carbon atoms or 1 to 4 carbon atoms substituted with a phenyl. When R² is part of a heterocyclic group that includes Q and the nitrogen to which R² is attached, the heterocyclic group typically is saturated or partially saturated and contains at least 4, at least 5, or at least 6 ring members.

Group Q is (a) an alkylene, (b) arylene, (c) a carbonylamino group linking a first group to a second group, wherein the first group and the second group are each independently an alkylene, arylene, or a combination thereof, (d) part of a heterocyclic group that includes R² and the nitrogen to which R² is attached, or (e) a combination thereof. Any suitable alkylene can be used for Q. Exemplary alkylene groups often have at least 2 carbon atoms, at least 4 carbon atoms, at least 6 carbon atoms, at least 10 carbon atoms, or at least 20 carbon atoms. Any suitable arylene can be used for Q. Exemplary arylenes often have 6 to 12 carbon atoms and include, but are not limited to, phenylene and biphenylene.

The group Q can be a combination of one or more alkylenes with one or more arylenes. An aralkylene (i.e., a group having an alkylene bonded to an arylene) is a particular combination of one alkylene and one arylene.

In one embodiment, Q is a cycloaliphatic group and a C2-C4 alkylene (e.g. ethylene) group, such as ethylene trimethylcyclohexyl. In another embodiment, Q is a C2-C8 alkylene (e.g. ethylene, propylene, butylene, pentylene, hexylene, heptylene, octylene) group.

The oxylamino compound can be prepared by the condensation reaction of an oxalate with an organic amine as described in US2012/271025; incorporated herein by reference.

Representative oxalates include for example dimethyl oxalate, diethyl oxalate, di-n-butyl oxalate, di-tert-butyl oxalate, and bis(phenyl)oxalate.

Exemplary diamines include alkylene diamines (i.e., Q is a alkylene) such as ethylene diamine, propylene diamine, butylene diamine, hexamethylene diamine, 2-methylpentamethylene 1,5-diamine (i.e., commercially available from DuPont, Wilmington, Delaware, under the trade designation DYTEK A), 1,3-pentane diamine (commercially available from DuPont under the trade designation DYTEK EP), 1,4-cyclohexane diamine, 1,2-cyclohexane diamine (commercially available from DuPont under the trade designation DHC-99), 4,4′-bis(aminocyclohexyl)methane, and 3-aminomethyl-3,5,5-trimethylcyclohexylamine. Exemplary aromatic diamines include for example arylene diamines (i.e., Q is an arylene such as phenylene) such as m-phenylene diamine, o-phenylene diamine, and p-phenylene diamine. Exemplary aralkylene diamines (i.e., Q is an alkylene-arylene group) include, but are not limited to, 4-aminomethyl-phenylamine, 3-aminomethyl-phenylamine, and 2-aminomethyl-phenylamine. Exemplary alkylene-aralkylene (i.e., Q is a alkylene-arylene-alkylene group) diamines include, but are not limited to, 4-aminomethyl-benzylamine (i.e, para-xylene diamine), 3-aminomethyl-benzylamine (i.e., meta-xylene diamine), and 2-aminomethyl-benzylamine (i.e., ortho-xylene diamine). Yet other exemplary diamines have one or more secondary amino groups that are part of a heterocyclic group, such as piperazine.

In typical embodiments, the functional compound comprising a free-radically polymerizable group has the formula:

R¹⁰-L-(M)ₚ
wherein R¹⁰ is hydroxyl, isocyanate, or alkylhalide (e.g. chloride); L is a polyvalent (e.g. divalent or trivalent) organic linking group; M is a (meth)acryl group (i.e. (meth)acrylate or (meth)acrylamide). “M” typically has the formula —XC(═O)C(R₁)═CH₂ wherein X is CO or NH and R₁ is H or alkyl of 1 to 4 carbon atoms (e.g. methyl), and p is 1 or 2. In some embodiments, M is a methacrylate functional group (R₁=methyl).

Suitable examples of hydroxy functional (meth)acrylates include for example, 2-hydroxyethyl methacrylate, hydroxypropyl methacrylate (all isomers), hydroxybutyl methacrylate (all isomers), poly(ε-caprolactone) mono[2-methacryloxy ethyl] esters, glycerol dimethacrylate, 1-(acryloxy)-3-(methacryloxy)-2-propanol, 2-hydroxy-3-phenyloxypropyl methacrylate, 2-hydroxyalkyl methacryloyl phosphate, 4-hydroxycyclohexyl methacrylate, trimethylolpropane dimethacrylate, trimethylolethane dimethacrylate, 1,4-butanediol monomethacrylate, neopentyl glycol monomethacrylate, 1,6-hexanediol monomethacrylate, 3-chloro-2-hydroxypropyl methacrylate, 2-hydroxy-3-alkyloxymethacrylate, polyethylene glycol monomethacrylate, polypropylene glycol monomethacrylate, —OH terminated ethylene oxide-modified phthalic acid methacrylate, 4-hydroxycyclohexyl methacrylate, acid chlorides and (meth)acrylic anhydride.

Representative isocyanate compounds comprising a free-radically polymerizable group include 2-isocyanatoethyl (meth)acrylate, 3-isocyanatopropyl (meth)acrylate, 4-isocyanatocyclohexyl (meth)acrylate, 4-isocyanatostyrene, 2-methyl-2-propenoyl isocyanate, 4-(2-(meth)acryloyloxyethoxycarbonylamino) phenylisocyanate, allyl 2-isocyanatoethylether, 3-isocyanato-1-propene, 3-isocyanato-1-propyne, and 3-isopropenyl-α,α-dimethylbenzyl isocyanate.

In some embodiments, L is a straight or branched chain or cycle-containing aliphatic (e.g. divalent) connecting group, such an alkylene. In other embodiments, L is an aromatic (e.g. divalent) connecting group, such as arylene, aralkylene, and alkarylene. L can optionally include heteroatoms such as O, N, and S, and combinations thereof. L can also optionally include a heteroatom-containing functional group such as carbonyl or sulfonyl, and combinations thereof. L typically comprises no greater than 20 carbon atoms.

In some embodiments, L is typically alkylene comprising no greater than 12, 10, 8 or 6 carbon atoms. In some embodiments, L is a C₂, C₃, or C₄ alkylene group. In some embodiments, p is 1.

In some embodiment, the dicarbonyl polymer may have the following Formula II.

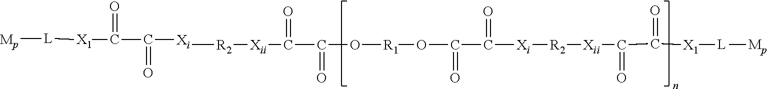

wherein
each —O—R₁—O— is independently a polymerized unit of a polymeric polyol;
X₁, Xᵢ and Xii are independently O or NR³ wherein R³ is H or an organic group;
each R₂ is independently an organic group;
n is at least 1, 2, 3, 4, 5, 6, 7, 8, 9, or 10;
L is a polyvalent linking group;
Mp is a free radical polymerizable group; and
p ranges from 1 to 3.

In other embodiments, the dicarbonyl polymer may have the following Formula III:

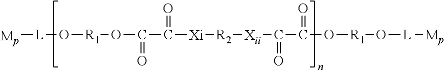

wherein
each —O—R₁—O— is independently a polymerized unit of a polymeric polyol;
Xi and Xii are independently O or NR³ wherein R is H or an organic group;
each R₂ is independently an organic group;
n is at least 1, 2, 3, 4, 5, 6, 7, 8, 9, or 10;
L is a polyvalent linking group;
Mp is a free radical polymerizable group; and
p ranges from 1 to 3.

The reaction product typically contains at least 75, 80, 85, 90, 95 wt. % or greater of the dicarbonyl polymer comprising polymerized units of oxamate and/or oxalate.

As depicted in the synthesis above, the synthesis of the dicarbonyl polymer can also produce by-products such as the reaction product of an oxylamino compound, as described above, and the coreactant comprising a free-radically polymerizable group (i.e. in the absence of polymeric diol). Thus, the by-product has the same formula as the oxylamino compound except that the terminal R¹ groups are —R¹⁰-L-(M)ₚ. Another by-product is the reaction product of the polymeric diol and the coreactant comprising a free-radically polymerizable group. Another byproduct is the reaction product of a diol and the coreactant comprising a free-radically polymerizable group such as depicted in Example 16. In some embodiments, such byproducts are present in the polymerizable resin in combination with the dicarbonyl polymer. Alternatively, such by-products can be removed from the dicarbonyl polymer and thus not be present in the polymerizable resin. The concentration of byproduct(s) in the polymerizable resin is typically no greater than 25, 20, 15, 10, 5, 4, 3, 2, or 1 wt. %.

In some embodiments, such as when the coreactant is a hydroxyl functional material, the synthesis of the dicarbonyl polymer can be free of isocyanate coreactants. Thus, the dicarbonyl and any by-products produced are also free of urethane linkages and any unreacted isocyanate coreactants. Thus, the polymerizable resin containing the dicarbonyl and optionally any by-products present are also free of urethane linkages and any unreacted isocyanate coreactants. Alternatively, any unreacted isocyanate coreactants can be removed prior to utilizing the dicarbonyl polymer as a 3D printable material or combining the dicarbonyl polymer with other free-radically polymerizable materials. The amount of unreacted isocyanate coreactants can be zero, less than a detectable amount, or less than 1, 0.5, 0.1 or 0.01 wt. %.

The dicarbonyl polymer has a molecular weight equal to the reaction product of at least one mole of polymeric diol, two moles of oxylamino compound, and two moles of (e.g. hydroxy-functional or isocyanate-functional) coreactant. In typical embodiments, the dicarbonyl has a molecular weight equal to the reaction product of at least two or more moles of polymeric diol, three or more moles of oxylamino compound, and two moles of (e.g. hydroxy-functional or isocyanate-functional) coreactant.

The number average molecular weight (Mn) of the dicarbonyl polymer is greater than 500, 550, 600, 650, 700, 750, 1000, 1250, 1500, 1750, 2000, 2250, 2500, 2750, or 3000 g/mole. In some embodiments, the molecular weight of the dicarbonyl polymer is a least 3500, 4000, 4500, 5000, 5500, 6000, 6500, 7000, 7500, or 8000 g/mole. The molecular weight of the dicarbonyl polymer is typically no greater than 25,000; 20,000; 15,000; or 10,000 g/mole. In some embodiments, the molecular weight of the dicarbonyl polymer is no greater than 9,000; 8,000; 7,000; 6,000; 5000; 4000; 3000; or 2000 g/mole.

The polydispersity of the dicarbonyl polymer is typically less than 2.5 or 2.0. In some embodiments, the polydispersity is less than 1.9, 1.8, 1.7, 1.6, 1.5, 1.4, 1.3, or 1.2.

Molecular weight (Mw and Mn) and polydispersity of the dicarbonyl polymer is determined by GPC as described in the example section.

Higher molecular weight dicarbonyl polymers typically have a higher viscosity. Lower molecular weight dicarbonyl polymers can result in the cured polymer or cured polymerizable composition failing to yield and/or exhibiting insufficient elongation (i.e. less than 15-20%); these are considered preferred properties for orthodontic aligners.

Molecular weight (Mw and Mn) of the dicarbonyl polymer is determined by GPC as described in the example section.

In some embodiments, the dicarbonyl polymer, the dicarbonyl polymer together with by-products, or a mixture of dicarbonyl polymers is suitable for use for 3D printing in the absence of any additional components.

The cured polymerizable composition comprising the dicarbonyl polymer in combination with (e.g. isobornyl methacrylate (IBOMA)) reactive diluent is typically a low Tg polymer having a Tg less than −20, −25, −30, −35, −40, −45, −50, −55, −60, or −65° C. In some embodiments, the Tg of the dicarbonyl polymer is at least −75 or −70° C. Since a homopolymer of IBOMA has a high Tg as will subsequently be described, it can be concluded that the dicarbonyl polymer also has a low Tg. The Tg of the dicarbonyl polymer can be in the same range as the cured polymerizable composition. The Tg can be measure by Differential Scanning Calorimetry (DSC) according to the test method described in the examples. In some embodiments, such as when the dicarbonyl polymer was prepared from a polyether polymeric polyol, the cured polymerizable composition exhibited two Tgs. The second Tg is typically at least 0, 5, 10, 15, or 20° C. The second Tg is typically no greater than 50, 45, 40, 35, 30, or 25° C.

### Additional Components of Polymerizable Resin

In other embodiments, a polymerizable resin is described comprising the dicarbonyl polymer as described herein in combination with a different free-radically polymerizable material. In these embodiments, the free-radically polymerizable resin typically comprises greater than 10, 15, 20, 25, 30, 35, 40, 45, 50, 55, 60, 65, 70, 75, 80, 85, or 90 wt. % of the dicarbonyl polymer as described herein. Thus, the amount of different free-radically polymerizable material (e.g. reactive diluent) is typically at least 10, 15, 20, 25, 30, 35, 40, 45, 50, 55, 60, 65, 70, 75, 80, 85, or 90 wt. % of the total polymerizable components.

In some embodiments, the polymerizable composition further comprises at least one free-radically polymerizable component (i.e. reactive diluent) having a molecular weight less than the dicarbonyl polymer, thereby lowering the viscosity. In typical embodiments, the reactive diluent has a molecular weight less than 1000, 900, 800, 700, 600, 500, or 400 g/mole.

In typical embodiments, the reactive diluent is a monofunctional, difunctional, or multifunctional (meth)acryl monomer.

Suitable free-radically polymerizable monofunctional diluents include phenoxy ethyl(meth)acrylate, phenoxy-2-methylethyl(meth)acrylate, phenoxyethoxyethyl(meth)acrylate, 3-hydroxy-2-hydroxypropyl(meth)acrylate, benzyl(meth)acrylate, phenylthio ethyl acrylate, 2-naphthylthio ethyl acrylate, 1-naphthylthio ethyl acrylate, 2,4,6-tribromophenoxy ethyl acrylate, 2,4-dibromophenoxy ethyl acrylate, 2-bromophenoxy ethyl acrylate, 1-naphthyloxy ethyl acrylate, 2-naphthyloxy ethyl acrylate, phenoxy 2-methylethyl acrylate, phenoxyethoxyethyl acrylate, 3-phenoxy-2-hydroxy propyl acrylate, 2,4-dibromo-6-sec-butylphenyl acrylate, 2,4-dibromo-6-isopropylphenyl (meth)acrylate, benzyl (meth)acrylate, phenyl (meth)acrylate, tetrahydrofurfuryl (meth)acrylate, alkoxylated tetrahydrofurfuryl acrylate, ethoxylated nonyl phenol (meth)acrylate, alkoxylated lauryl (meth)acrylate, alkoxylated phenol (meth)acrylate, stearyl (meth)acrylate, tetrahydrofurfuryl (meth)acrylate, lauryl (meth)acrylate, isodecyl (meth)acrylate, isooctyl (meth)acrylate, octadecyl (meth)acrylate, tridecyl (meth)acrylate, ethoxylated (4) nonyl phenol (meth)acrylate, caprolactone (meth)acrylate, cyclic trimethylolpropane formal (meth)acrylate, 3,3,5-trimethylcyclohexyl (meth)acrylate, dicyclopentadienyl (meth)acrylate, isobutyl (meth)acrylate, n-butyl (meth)acrylate, ethyl hexyl (meth)acrylate, isobornyl (meth)acrylate, and 2,4,6-tribromophenyl (meth)acrylate.

Suitable free-radically polymerizable multifunctional diluents include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, propoxylated glycerin tri(meth)acrylate, and mixtures thereof.

In some embodiments, the polymerizable resin comprises a (e.g. monofunctional) reactive diluent exhibiting a hydrophilic-lipophilic balance (HLB) value of less than 10. As used herein, HLB refers to the value obtained by the Griffin's method (See Griffin, W. C.: “Calculation of HLB Values of Non-Ionic Surfactants,” Journal of the Society of Cosmetic Chemists 5 (1954): 259); the computation conducted utilizing the software program Molecular Modeling Pro Plus from Norgwyn Montgomery Software, Inc. (North Wales, Pa.). The HLB of some reactive diluent is described in the following table.

Hydrophilic-Lipophilic Balance (HLB) Values

| Compound | HLB |
|---|---|
| 2-Ethyl Hexyl Methacrylate | 3.4 |
| Hydroxyethyl Methacrylate | 12.4 |
| Isobutylmethacrylate | 4.2 |
| Isobornyl methacrylate | 1.9 |
| Phenoxyethyl methacrylate | 5.6 |
| Exothane 10 | 13.8 |
| H1188 | 5.3 |
| U847 | 4.9 |

According to Griffin's method: HLB=20*Mh/M where Mh is the molecular mass of the hydrophilic portion of the molecule, and M is the molecular mass of the whole molecule. This computation provides a numerical result on a scale of 0 to 20, wherein “0” is highly lipophilic. In some embodiments, the reactive diluent exhibits a hydrophilic-lipophilic balance (HLB) value of less than 9, 8, 7, 6, 5, 4, 3, or 2. In some embodiments, the HLB is at least 1 or 1.5.

In some embodiments, the polymerizable composition further comprises at least one free-radically polymerizable component having a Tg greater than the dicarbonyl polymer. In typical embodiments, the free radically polymerizable component has a Tg of at least 25, 30, 35, 40, 45, 50, 60, 65, 70, 75, 80, 85, 90, 100, 110, 115, 120, 125, 130, 135, 140, 145, or 150° C. In some embodiments, the free radically polymerizable component has a Tg of at least 155, 160, 165, 170, 175, 180, 185, or 190° C. In some embodiments, the free radically polymerizable component has a Tg of no greater than 255, 250, 245, 240, 235, 230, 225, 220, 215, 210, 205, or 200° C.

In some embodiments, the lower molecular weight and higher Tg free-radically polymerizable components can be two or more different components. However, in favored embodiments, the reactive diluent has a Tg greater than the dicarbonyl polymer.

In some embodiments, the high Tg (e.g. monofunctional) reactive diluent comprises a cyclic moiety. Although the cyclic moiety may be aromatic, in typical embodiments, the cyclic moiety is a cycloaliphatic. Suitable monofunctional (meth)acrylate monomers include for instance and without limitation, 3,3,5-trimethylcyclohexyl (meth)acrylate, butyl-cyclohexyl(meth)acrylate, 2-decahydronapthyl (meth)acrylate, 1-adamantyl (meth)acrylate, dicyclopentadienyl (meth)acrylate, bornyl (meth)acrylate including isobornyl (meth)acrylate, dimethyl-1-adamantyl (meth)acrylate, and 3-tetracyclo[4.4.0.1.1]dodecyl methacrylate.

When the polymerized composition contacts an aqueous environment during normal use, such as in the case of orthodontic articles, it is advantageous to utilize materials that have low affinity for water. One way to express the affinity for water of (meth)acrylate monomers is by calculation of the partition coefficient between water and an immiscible solvent, such as octanol. This can serve as a quantitative descriptor of hydrophilicity or lipophilicity. The octanol/water partition coefficient can be calculated by software programs such as ACD ChemSketch, (Advanced Chemistry Development, Inc., Toronto, Canada) using the log P module. In some embodiments, the (e.g. monofunctional (meth)acrylate monomer) reactive diluent(s) has a calculated log P value of greater than 1, 1.5, 2, 2.5, or 3. In some embodiments, the (e.g. monofunctional (meth)acrylate monomer) reactive diluents(s) has a calculated log P value of greater than 3.5, 4. 4.5, or 5. The calculated log P value is typically no greater than 12.5. In some embodiments, the calculated log P value is no greater than 12, 11.5, 11, 10.5, 10, 9.5, 9, 8.5, 8, 7.5, 7, 6.5, 6, or 5.5. In some embodiments, the polymerizable resin comprises greater than 10 wt. % of monofunctional (meth)acrylate monomers having a log P of at least 3.5.

In some embodiments, the polymerizable composition optionally further comprises a (e.g. monofunctional (meth)acrylate monomer) reactive diluent having a high affinity for water, i.e. having a log P value of less than 3, 2.5, 2.0, 1.5, or 1. When present, such reactive diluent(s) are typically present in an amount less than the reactive diluent(s) having a low affinity for water.

In some embodiments, the concentration of (e.g. monofunctional (meth)acryl monomer(s)) reactive diluent(s) having a high affinity for water is no greater than 50, 45, 40, 35, 30, or 25 wt. % of the total (e.g. monofunctional (meth)acrylate monomer(s)) reactive diluent(s). In some embodiments, the concentration of (e.g. monofunctional (meth)acryl monomer(s)) reactive diluent(s) having a high affinity for water is no greater than 24, 23, 22, 21, 20, 19, 18, 17, 16, 15, 14, 13, 12, 11, 10, 9, 8, 7, 6, 5, 4, 3, 2, or 1 wt. % of the total monofunctional (meth)acrylate monomer(s).

In some embodiments, the total polymerizable composition comprises no greater than 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 wt. % of reactive diluent(s) having a high affinity for water. In some embodiments, the total polymerizable composition comprises at least 1, 2, 3, 4, 5, 6, 7, 8, 9, 10, 11, 12, 13, 14, 15, 16, 17, 18, 19, or 20 wt. % of reactive diluent(s) (e.g. (meth)acrylate monomer(s)) having a high affinity for water.

The Tg and log P of various (e.g. monofunctional (meth)acryl monomers) are reported in the following table. The Tg of a monome is the Tg of a homopolymer of that monomer.

TABLE 1
Reported glass transition temperature (T_{g}) and calculated log P (log of octanol/water
partition coefficient) of homopolymers of monofunctional (meth)acrylate monomers.

| | | | Calculated |
|---|---|---|---|
| Monomer | Tg (° C.) | T_{g} Reference | log P |
| 3,3,5-trimethylcyclohexyl acrylate | 15 | Hopfinger et. al.; J. Polym. Sci. | 4.38 |
| | | B., Polym. Phys. 1988, 26, | |
| | | 2007 | |
| d,l-isobornyl acrylate | 94 | Jakubowski et. al. Polymer, | 4.22 |
| | | 2008, 49, 1567 | |
| dicyclopentanyl acrylate | 103 | U.S. Pat. No. 4,591,626 | 3.69 |
| 3,5-dimethyl-1-adamantyl acrylate | 105 | Matsumoto, A. et. al. | 4.63 |
| | | Macromolecules 1991, 24, | |
| | | 4017 | |
| cyclohexyl methacrylate | 107 | Wilson, P. S., Simha, R.; | 3.41 |
| | | Macromolecules, 1973, 95, 3, | |
| | | 902 | |
| tert-butyl methacrylate | 113 | Matsumoto, A. et. al. | 2.57 |
| | | Macromolecules 1991, 24, | |
| | | 4017 | |
| 3,3,5-trimethylcyclohexyl | 125 | Hopfinger et. al.; J. Polym. Sci. | 4.93 |
| methacrylate | | B., Polym. Phys. 1988, 26, | |
| | | 2007 | |
| cis-4-tert-butyl- | 132 | Matsumoto, A. et. al. | 5.13 |
| cyclohexylmethacrylate | | Macromolecules 1993, 26, 7, | |
| | | 1659 | |
| 2-decahydronapthyl methacrylate | 145 | Matsumoto, A. et. al., J. Polym. | 4.95 |
| | | Sci. A., Polym. Chem. 1993, | |
| | | 31, 2531 | |
| 1-adamantyl acrylate | 153 | Matsumoto, A. et. al. | 3.68 |
| | | Macromolecules 1991, 24, | |
| | | 4017 | |
| Mixture of 73% trans-4-tert- | 163 | Matsumoto, A. et. al. | 5.13 |
| butylcyclohexylmethacrylate/27% cis- | | Macromolecules 1993, 26, 7, | |
| 4-tert-butylcyclohexylmethacrylate | | 1659 | |
| dicyclopentanyl methacrylate | 173 | U.S. Pat. No. 4,591,626 | 4.24 |
| trans-4-tert-butylcyclohexyl | 178 | Matsumoto, A. et. al. | 5.13 |
| methacrylate | | Macromolecules 1993, 26, 7, | |
| | | 1659 | |
| d,l-isobornyl methacrylate | 191 | Matsumoto, A. et. al., J. Polym. | 4.77 |
| | | Sci. A., Polym. Chem. 1993, | |
| | | 31, 2531 | |
| 3,5-dimethyl-1-adamantyl | 194 | Matsumoto, A. et. al. | 5.19 |
| methacrylate | | Macromolecules 1991, 24, | |
| | | 4017 | |
| d,l-bornyl methacrylate | 194 | Matsumoto, A. et. al., J. Polym. | 4.77 |
| | | Sci. A., Polym. Chem. 1993, | |
| | | 31, 2531 | |
| 3-tetracyclo[4.4.0.1.1]dodecyl | 199 | Matsumoto, A. et. al., J. Polym. | 4.66 |
| methacrylate | | Sci. A., Polym. Chem. 1993, | |
| | | 31, 2531 | |
| 1-adamantyl methacrylate | >253 | Matsumoto, A. et. al. | 4.23 |
| | | Macromolecules 1991, 24, | |
| | | 4017 | |
| 2-ethylhexyl methacrylate | −10 | Fleischhaker et. al., Macromol. | 4.88 |
| | | Chem. Phys. 2014, 215, 1192. | |
| tetrahydrofurfuryl methacrylate | 60 | E. I. du Pont de Nemours & Co., | 1.38 |
| | | Ind. Eng. Chem., 1936, 28, | |
| | | 1160, | |
| 2-phenoxyethyl methacrylate | 47 | Song et. al.; J. Phys. Chem. B | 3.26 |
| | | 2010, 114, 7172 | |
| N-vinyl pyrrolidone | 180 | Turner et. al; Polymer, 1985, | 0.37 |
| | | 26, 757 | |
| carboxyethyl acrylate | <30 | Fang et. al.; Int. J. Adhes. and | 0.60 |
| | | Adhes. 84 (2018) 387-393 | |
| 2-hydroxyethyl methacrylate | 105 | Russell et. al.; J. Polym. Sci. | 0.50 |
| | | Polym. Phys, 1980, 18, 1271 | |
| acryloyl morpholine | 147 | Elles, J.; Chimie Moderne, | −0.94 |
| | | 1959, 4, 26, 53 | |
| Isobutylmethacrylate | 48 | Krause, S. et. al. J. Polym. Sci. | 2.76 |
| | | A. 1965, 3, 3573-3586 | |
| Tertiary butyl acrylate | 44 | BASF Specialty monomers | 2.02 |
| | | Technical data catalog | |
| Benzyl methacrylate | 72 | Munoz, M. I et al. | 2.82 |
| | | Thermochimica Acta 1989, 146, | |
| | | 137-147. | |
| n-Propylmethacrylate | 35 | Rogers, S. S. et. al. J. Phys. | 2.41 |
| | | Chem. 1957, 61, 985-991 | |

In some embodiments, the polymerizable resin comprises at least one ethylenically unsaturated component with acid functionality as described in WO 2020/003169. The ethylenically unsaturated component with acid functionality can function as a reactive diluent and thus can have the same molecular weight as previously described for the reactive diluent. In typical embodiments, the ethylenically unsaturated component with acid functionality has a high affinity for water, such as in the case of (meth)acrylic acid or carboxy ethyl acrylate.

### Initiators

Photopolymerizable compositions described herein, in some instances, further comprise one or more additives, such as one or more additives selected from the group consisting of photoinitiators, thermal initiators, inhibitors, stabilizing agents, sensitizers, absorption modifiers, fillers and combinations thereof. For example, the photopolymerizable composition further comprises one or more photoinitiators, for instance two photoinitiators. Suitable exemplary photoinitiators are those available under the trade designations IRGACURE and DAROCUR from BASF (Ludwigshafen, Germany) and include 1-hydroxycyclohexyl phenyl ketone (IRGACURE 184), 2,2-dimethoxy-1,2-diphenylethan-1-one (IRGACURE 651), bis(2,4,6 trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), oligo[2-hydroxy-2-methyl-1-[4-(1-methylvinyl)phenyl]propanone] ESACURE KIP 150 (Lamberti S.p.A., Gallarate, Italy), 2-hydroxy-2-methyl-1-phenyl propan-1-one (DAROCUR 1173), 2,4,6-trimethylbenzoyldiphenylphosphine oxide (IRGACURE TPO), and 2,4,6-trimethylbenzoylphenyl phosphinate (IRGACURE TPO-L). Additional suitable photoinitiators include for example and without limitation, benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

A thermal initiator can be present in a photopolymerizable composition described herein in any amount according to the particular constraints of the additive manufacturing process. In some embodiments, a thermal initiator is present in a photopolymerizable composition in an amount of up to about 5% by weight, based on the total weight of the photopolymerizable composition. In some cases, a thermal initiator is present in an amount of about 0.1-5% by weight, based on the total weight of the photopolymerizable composition. Suitable thermal initiators include for instance and without limitation, peroxides such as benzoyl peroxide, dibenzoyl peroxide, dilauryl peroxide, cyclohexane peroxide, methyl ethyl ketone peroxide, hydroperoxides (e.g., tert-butyl hydroperoxide and cumene hydroperoxide), dicyclohexyl peroxydicarbonate, 2,2′-azo-bis(isobutyronitrile), and t-butyl perbenzoate. Examples of commercially available thermal initiators include initiators available from Chemours Co. (Wilmington, DE) under the VAZO trade designation including VAZO 67 (2,2′-azo-bis(2-methybutyronitrile)) VAZO 64 (2,2′-azo-bis(isobutyronitrile)) and VAZO 52 (2,2′-azo-bis(2,2-dimethyvaleronitrile)), and LUCIDOL 70 from Elf Atochem North America, Philadelphia, PA.

In some embodiments, the photopolymerizable compositions described herein comprise a polymer or macromolecule comprising one or more free-radical photoinitiator groups as described in International Application Publication No. WO2019/104072.

In some embodiments, the photopolymerizable composition comprises at least two different photoinitiators selected based on absorbance properties of the photoinitiators as described in International Application Publication No. WO2019/104079. The polymer or macromolecule comprising a photointiator group can be the first and/or second photoinitiator.

In some embodiments, the first free-radical photoinitiator has sufficient absorbance at a wavelength of a first wavelength range. In some embodiments, the first wavelength range is 375-450 nm. In some embodiments, the wavelength of absorbance of the first free-radical photoinitiator is 385 nm.

The second free-radical photoinitiator) has sufficient absorbance at a second wavelength range. The second wavelength range is a different wavelength range than the first wavelength range. In some embodiments, the second wavelength range is 360 nm up to but not including 375 nm. In some embodiments, the wavelength of absorbance of the second free-radical photoinitiator is 365 nm. In some embodiments, the second photoinitiator typically has two absorption wavelength maximums. The first absorption wavelength maximum ranges from 250 nm-275 nm.

The second absorption wavelength maximum ranges from 325 nm-330 nm. In some embodiments, the second photoinitiator does not have an absorption wavelength maximum in the second wavelength range. However, second photoinitiator provides sufficient absorbance at 365 nm. In some embodiments, the first photoinitiator has an absorbance at 385 nm greater than the second photoinitiator by a factor of 5X ranging up to 10X, 50X, 100X, 150X, 200X, 250X, or 300X.

### Additives

Photopolymerizable compositions described herein may further comprise one or more additives including polymerization inhibitors (e,g. methoxyhydroquinone), stabilizing agents (e.g. antioxidants such as butylated hydroxytoluene (BHT), sensitizers (e.g. isopropylthioxanthone or 2-chlorothioxanthone), absorption modifiers (e.g., colorants, dyes, optical brighteners, pigments), fillers particles and fibers, and combinations thereof. Examples of such additives are described in previously cited WO 2020/003169.

Various particulate inorganic and organic fillers are known. The fillers may have an average particle size less than (i.e. nanoparticle) or greater than 1 micron. Examples of suitable fillers are naturally occurring or synthetic materials including, but not limited to: silica (SiO₂ (e.g., quartz)); alumina (Al₂O₃), zirconia, nitrides (e.g., silicon nitride); glasses and ceramic fillers derived from, for example, Zr, Sr, Ce, Sb, Sn, Ba, Zn, and Al; feldspar; borosilicate glass; kaolin (china clay); talc; zirconia; titania; and submicron silica particles (e.g., pyrogenic silicas such as those available under the trade designations AEROSIL, including “OX 50,” “130,” “150” and “200” silicas from Degussa Corp., Akron, OH and CAB-O-SIL M5 and TS-720 silica from Cabot Corp., Tuscola, IL). Organic fillers made from polymeric materials are also possible, such as those disclosed in International Publication No. WO09/045752 (Kalgutkar et al.). The fillers may be surface modified.

In some embodiments, the compositions further comprise inorganic nanoparticles, such as silica. In some embodiments, the average particle size is typically at least 5 or 10 nm and no greater than 100, 75, or 50 nm. At concentrations of 25 wt. % or greater, the composition typically exhibits insufficient elongation. Hence, the concentration of (e.g. silica) inorganic nanoparticles is typically less than 25, 24, 23, 22, 21, 20, 19, 18, 17, 16, 15, 14, 13, 12, or 10 wt. % based on the total weight of the polymerizable composition. In some embodiments, the composition comprises at least 1, 2, 3, 4, or 5 wt. % (e.g. silica) inorganic nanoparticles based on the total weight of the polymerizable composition.

The use of florescent dyes and pigments can be beneficial in enabling the printed composition to be viewed under black-light. A particularly useful hydrocarbon soluble fluorescing dye is 2,5-bis(5-tert-butyl-2-benzoxazolyl) 1 thiophene. Fluorescing dyes, such as rhodamine, may also be bound to cationic polymers and incorporated as part of the resin.

If desired, the polymerizable compositions may contain other additives such as indicators, accelerators, surfactants, wetting agents, antioxidants, tartaric acid, chelating agents, buffering agents, and other similar ingredients that will be apparent to those skilled in the art. Additionally, medicaments or other therapeutic substances can be optionally added to the photopolymerizable compositions. Examples include, but are not limited to, fluoride sources, whitening agents, anticaries agents (e.g., xylitol), remineralizing agents (e.g., calcium phosphate compounds and other calcium sources and phosphate sources), enzymes, breath fresheners, anesthetics, clotting agents, acid neutralizers, chemotherapeutic agents, immune response modifiers, thixotropes, polyols, anti-inflammatory agents, antimicrobial agents (e.g. such as described in 82036), antifungal agents, agents for treating xerostomia, desensitizers, and the like, of the type often used in dental compositions.

Combinations of various additives may also be employed. Although fillers can be used at higher concentration as previously described, the total amount of other additives is typically no greater than 10, 9, 8, 7, 6, 5, 4, 3, 2, or 1 wt. % of the total composition.

In some embodiments, the (e.g. photo)polymerizable composition has a viscosity profile consistent with the requirements and parameters of one or more additive manufacturing devices (e.g., 3D printing systems). In some instances, the polymerizable composition exhibits a dynamic viscosity of about 0.1-1,000 Pa·s, about 0.1-100 Pa·s, or about 1-10 Pa·s, using a TA Instruments AR-G2 magnetic bearing rheometer using a 40 mm cone and plate measuring system at 40 degrees Celsius and at a shear rate of 0.1 1/s, when measured according to ASTM D4287, as set forth in the Example Test Method below. In some cases, the polymerizable composition exhibits a dynamic viscosity of less than about 10 Pa·s, at 25, 30, 35 or 40° C. when measured according to modified ASTM D4287.

### Articles and Methods

In another aspect, the present disclosure provides an (e.g. orthodontic) article. The article comprises a reaction product of the photopolymerizable composition described herein.

In many embodiments, the photopolymerizable composition of the article is vat polymerized, as discussed in detail below.

The shape of the article is not limited, and may comprise a film or a shaped integral article. For instance, a film may readily be prepared by casting the photopolymerizable composition according to the first aspect, then subjecting the cast composition to actinic radiation to polymerize the photopolymerizable composition. In many embodiments, the article comprises a shaped integral article, in which more than one variation in dimension is provided by a single integral article. For example, the article can comprise one or more channels, one or more undercuts, one or more perforations, or combinations thereof. Such features are typically not possible to provide in an integral article using conventional molding methods. In some embodiments, the article comprises a plurality of layers. In select embodiments, the article comprises an orthodontic article. Orthodontic articles are described in further detail below.

In another aspect, the present disclosure provides a method of making an (e.g. orthodontic) article. The method comprises:
(a) providing a photopolymerizable composition, as described herein;
(b) selectively curing the photopolymerizable composition to form an article; and
(c) optionally curing unpolymerized dicarbonyl polymer and/or free radically polymerizable components remaining after step (b).

In many embodiments, the photopolymerizable composition is cured using actinic radiation comprising UV radiation, e-beam radiation, visible radiation, or a combination thereof. Moreover, the method optionally further comprises postcuring the article using actinic radiation or heat.

In additive manufacturing methods, the method further comprises (d) repeating steps (a) and (b) to form multiple layers and create the article comprising a three-dimensional structure prior to step (c). In certain embodiments, the method comprises vat polymerization of the photopolymerizable composition. When vat polymerization is employed, the radiation may be directed through a wall of a container (e.g., a vat) holding the photopolymerizable composition, such as a side wall or a bottom wall (e.g., floor).

In some embodiments, the method further comprises (e) subjecting the article to heating in an oven, for instance a vacuum oven. Typically, the oven is set at a temperature of 60° C. or higher. A stepwise heating process is optional, such as heating at 60° C., then at 80° C., and then at 100° C. Subjecting the article to heating is often performed to drive off unreacted reactive diluent remaining in the article.

A (photo)polymerizable composition described herein in a cured state, in some embodiments, can exhibit one or more desired properties. A (photo)polymerizable composition in a “cured” state can comprise a (photo)polymerizable composition that includes a polymerizable component that has been at least partially polymerized and/or crosslinked. In some cases, a cured (photo)polymerizable composition is at least 50%, 60%, 70%, 80%, or at least 90% or greater polymerized or crosslinked.

The photopolymerizable compositions can typically be characterized by at least one physical property after hardening. The test specimens can be prepared by casting and curing or 3D printing the photopolymerizable resin.

In some embodiments, the cured (e.g. casted or 3D printed) photopolymerizable composition described herein has an elongation at break of at least 15, 16, 17, 18, 19 or 20%. In some embodiments, the elongation at break is at least 25, 30, 35, 40, 45 or 50%. The elongation at break of the cured article can range up to 75, 100, 200, 300, 400, or 500%. In some embodiments, the elongation at break is at least 30% and no greater than 100%. Such elongation properties can be measured, for example, by the methods outlined in ASTM D638-10, using test specimen Type V.

The ultimate tensile strength and tensile strength at yield of the cured (e.g. cast or 3D printed) photopolymerizable composition described herein is typically at least 10 or 15 MegaPascals (MPa) ranging up to 50, 5, 60, 65, 70, or 75 MPA as determined according to ASTM D638-10. The yield strain can be less than 10 or 5%. The dicarbonyl polymer component typically has the greatest effect on the elongation at break of an article.

The Young's tensile elastic modulus of the cured (e.g. cast or 3D printed) photopolymerizable composition described herein is typically at least 250, 500, 750 or 1000 MPa as determined according to ASTM D638-10. The tensile modulus is typically no greater than 2,000; or 1,500 MPa.

In some embodiments, the cured (e.g. cast or 3D printed) photopolymerizable composition described herein have the elongation properties described above after conditioning (i.e., soaking) of a sample of the material of the orthodontic article in water or phosphate-buffered saline having a pH of 7.4, for 24 hours at a temperature of 37° C. (“PBS Conditioning”).

The cured (i.e. polymerized) composition (or orthodontic article prepared from such article) is of sufficient strength and flexibility such that the cured composition yields. Strength at yield is the maximum point on a stress-strain plot where permanent material deformation begins. An example of a stress-strain plot of a cured composition that yields has a peak before a plateau region. A stress-strain plot for a (e.g. brittle) cured composition that does not yield is typically linear over the full range of strain, eventually terminating in fracture without appreciable plastic flow. When the composition is too brittle, the cured composition does not yield and exhibits low elongation at break.

Photopolymerizable compositions described herein can be mixed by known techniques. In some embodiments, for instance, a method for the preparation of a photopolymerizable composition described herein comprises the steps of mixing all or substantially all of the components of the photopolymerizable composition, heating the mixture, and optionally filtering the heated mixture. Softening the mixture, in some embodiments, is carried out at a temperature of about 50° C. or in a range from about 50° C. to about 85° C. In some embodiments, a photopolymerizable composition described herein is produced by placing all or substantially all components of the composition in a reaction vessel and heating the resulting mixture to a temperature ranging from about 50° C. to about 85° C. with stirring. The heating and stirring are continued until the mixture attains a substantially homogenized state.

### Fabricating an Article

The (e.g. photo)polymerizable compositions described herein may be used in various manufacturing processes to create a variety of articles.

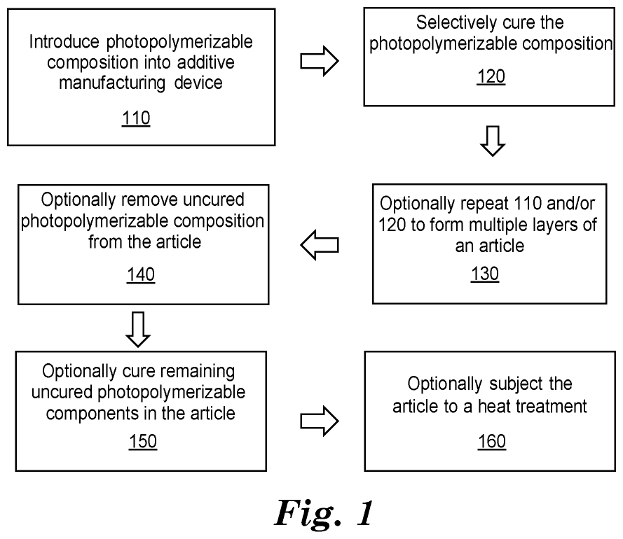

In some embodiments, the (e.g. photo)polymerizable compositions described herein are suitable for used for additive manufacturing processes. A general method 100 for creating three-dimensional articles is illustrated in FIG. 1. Step 110 introducing the (e.g. photo)polymerizable composition into a reservoir, cartridge, or other suitable container for use by or into an additive manufacturing device. The additive manufacturing device selectively cures the photopolymerizable composition according to a set of computerized design instructions in Step 120. In Step 130, Step 110 and/or Step 120 is repeated to form multiple layers to create the article comprising a three-dimensional structure (e.g., an orthodontic aligner). Optionally uncured photopolymerizable composition is removed from the article in Step 140. Optionally, the article is subjected to additional (e.g. photo)curing to polymerize remaining uncured photopolymerizable components in the article in Step 150. The article may also optionally be subjected to heat to volatilize or polymerize remaining unreacted reactive diluent in Step 160.

Methods of printing a three-dimensional article or object described herein can include forming the article from a plurality of layers of a (e.g. photo)polymerizable composition described herein in a layer-by-layer manner. Further, the layers of a build material composition can be deposited according to an image of the three-dimensional article in a computer readable format. In some or all embodiments, the photopolymerizable composition is deposited using data representing a three-dimensional object, most commonly (e.g. preselected) computer aided design (CAD) parameters.

Additionally, it is to be understood that methods of manufacturing a 3D article described herein can include so-called “stereolithography/vat polymerization” 3D printing methods. Other techniques for three-dimensional manufacturing may be suitably adapted to use in the polymerizable compositions described herein.

In some embodiments, a 3D article may be formed from a photopolymerizable composition described herein using vat polymerization (e.g., stereolithography). Such method comprises retaining a photopolymerizable composition described herein in a fluid state in a container and selectively applying energy to the photopolymerizable composition in the container to solidify at least a portion of a fluid layer of the photopolymerizable composition, thereby forming a hardened layer that defines a cross-section of the 3D article. Additionally, such method can further comprise raising or lowering the hardened layer of photopolymerizable composition to provide a new or second fluid layer of unhardened photopolymerizable composition at the surface of the fluid in the container, followed by again selectively applying energy to the photopolymerizable composition in the container to solidify at least a portion of the new or second fluid layer of the photopolymerizable composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photopolymerizable composition. Moreover, selectively applying energy to the photopolymerizable composition in the container can comprise applying actinic radiation, such as UV radiation, visible radiation, or e-beam radiation, having a sufficient energy to cure the photopolymerizable composition. A method described herein can also comprise planarizing a new layer of fluid photopolymerizable composition provided by raising or lowering an elevator platform. Such planarization can be carried out, in some cases, by utilizing a wiper or roller or a recoater bead. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable stereolithography printers include the Viper Pro SLA, available from 3D Systems, Rock Hill, SC and the Asiga Pico Plus39, available from Asiga USA, Anaheim Hills, CA.

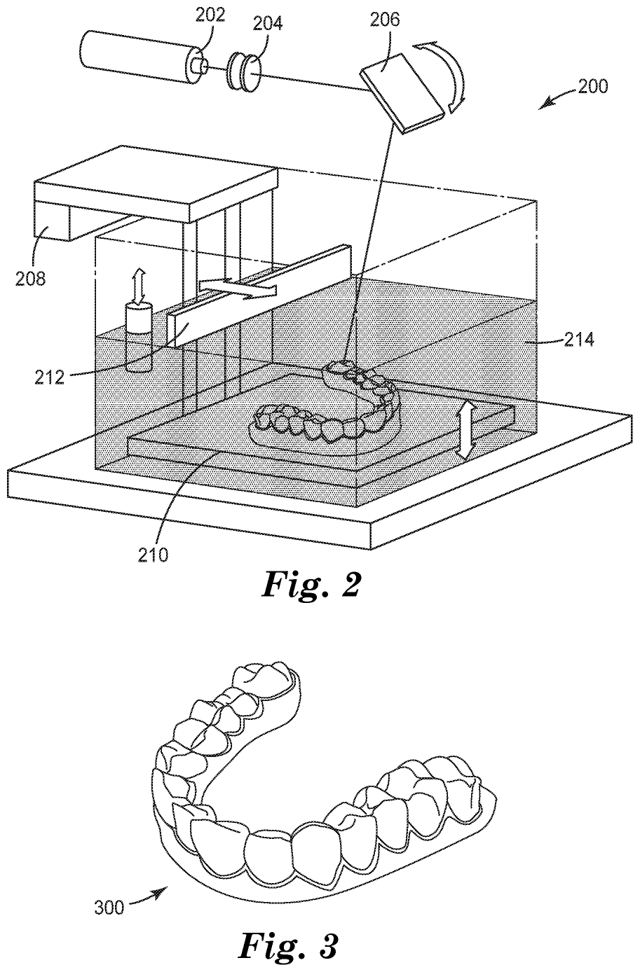

FIG. 2 shows an exemplary stereolithography apparatus (“SLA”) that may be used with the photopolymerizable compositions and methods described herein. In general, the SLA 200 may include a laser 202, optics 204, a steering lens 206, an elevator 208, a platform 210, and a straight edge 212, within a vat 214 filled with the photopolymerizable composition. In operation, the laser 202 is steered across a surface of the photopolymerizable composition to cure a cross-section of the photopolymerizable composition, after which the elevator 208 slightly lowers the platform 210 and another cross section is cured. The straight edge 212 may sweep the surface of the cured composition between layers to smooth and normalize the surface prior to addition of a new layer. In other embodiments, the vat 214 may be slowly filled with liquid resin while an article is drawn, layer by layer, onto the top surface of the photopolymerizable composition.

A related technology, vat polymerization with Digital Light Processing (“DLP”), also employs a container of curable polymer (e.g., photopolymerizable composition). However, in a DLP based system, a two-dimensional cross section is projected onto the curable material to cure the desired section of an entire plane transverse to the projected beam at one time. All such curable polymer systems as may be adapted to use with the photopolymerizable compositions described herein are intended to fall within the scope of the term “vat polymerization system” as used herein. In certain embodiments, an apparatus adapted to be used in a continuous mode may be employed, such as an apparatus commercially available from Carbon 3D, Inc. (Redwood City, CA), for instance as described in U.S. Pat. Nos. 9,205,601 and 9,360,757 (both to DeSimone et al.).

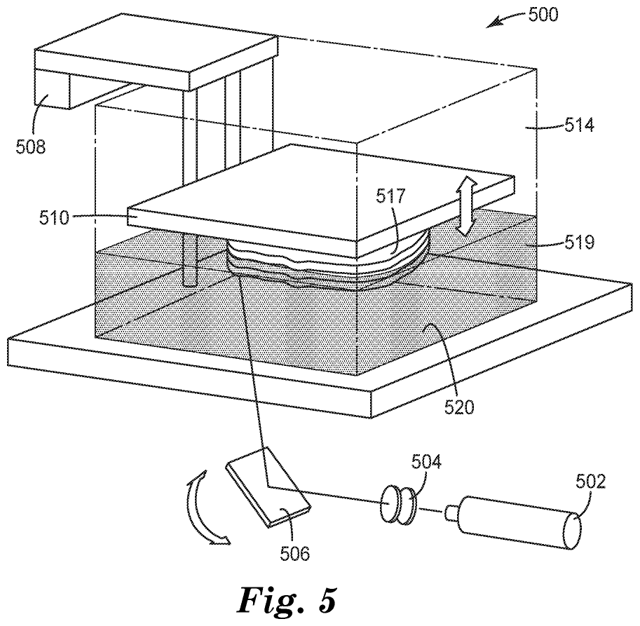

Referring to FIG. 5, a general schematic is provided of another SLA apparatus that may be used with photopolymerizable compositions and methods described herein. In general, the apparatus 500 may include a laser 502, optics 504, a steering lens 506, an elevator 508, and a platform 510, within a vat 514 filled with the photopolymerizable composition 519. In operation, the laser 502 is steered through a wall 520 (e.g., the floor) of the vat 514 and into the photopolymerizable composition to cure a cross-section of the photopolymerizable composition 519 to form an article 517, after which the elevator 508 slightly raises the platform 510 and another cross section is cured.

Other 3D printing techniques use inks that are jetted through a print head as a liquid to form various three-dimensional articles. In operation, the print head may deposit curable photopolymers in a layer-by-layer fashion. Some jet printers deposit a polymer in conjunction with a support material or a bonding agent. In some instances, the build material is solid at ambient temperatures and converts to liquid at elevated jetting temperatures. In other instances, the build material is liquid at ambient temperatures.

More generally, the photopolymerizable composition is typically cured using actinic radiation, such as UV radiation, e-beam radiation, visible radiation, or any combination thereof. The skilled practitioner can select a suitable radiation source and range of wavelengths for a particular application without undue experimentation.

After the 3D article has been formed, it is typically removed from the additive manufacturing apparatus and rinsed, e.g., an ultrasonic, or bubbling, or spray rinse in a solvent, which would dissolve a portion of the uncured photopolymerizable composition but not the cured, solid state article (e.g., green body). Any other suitable method for cleaning the article and removing uncured material at the article surface may also be utilized. At this stage, the three-dimensional article typically has sufficient green strength for handling in the remaining optional steps of method 100.

In some embodiments, the formed article obtained in Step 120 will shrink (i.e., reduce in volume) such that the dimensions of the article after (optional) Step 150 will be smaller than expected. For example, a cured article may shrink less than 5% in volume, less than 4%, less than 3%, less than 2%, or even less than 1% in volume, which is contrast to other compositions that provide articles that shrink about 6-8% in volume upon optional postcuring. Small amounts of volume percent shrinkage will not typically result in a significant distortion in the shape of the final object. Dimensions in the digital representation of the eventual cured article may be scaled according to a global scale factor to compensate for this shrinkage. For example, in some embodiments, at least a portion of the digital article representation can be at least 101% of the desired size of the printed appliance, in some embodiments at least 102%, in some embodiments at least 104%, in some embodiments, at least 105%, and in some embodiments, at least 110%.

A global scale factor may be calculated for any given photopolymerizable composition formulation by creating a calibration part according to Steps 110 and 120 above. The dimensions of the calibration article can be measured prior to postcuring.

In general, the three-dimensional article formed by initial additive manufacturing in Step 120, as discussed above, is typically not fully cured, by which is meant that not all of the photopolymerizable material in the composition has polymerized even after rinsing. Some uncured photopolymerizable material is typically removed from the surface of the printed article during a cleaning process (e.g., optional Step 140). The article surface, as well as the bulk article itself, typically still retains uncured photopolymerizable material, suggesting further cure. Removing residual uncured photopolymerizable composition is particularly useful when the article is going to subsequently be postcured, to minimize uncured residual photopolymerizable composition from undesirably curing directly onto the article.

Further curing can be accomplished by further irradiating with actinic radiation, heating, or both. Exposure to actinic radiation can be accomplished with any convenient radiation source, generally UV radiation, visible radiation, and/or e-beam radiation, for a time ranging from about 10 to over 60 minutes. Heating is generally carried out at a temperature in the range of about 75-150° C., for a time ranging from about 10 to over 60 minutes in an inert atmosphere. So called post cure ovens, which combine UV radiation and thermal energy, are particularly well suited for use in the postcure process of Step 150. In general, postcuring improves the mechanical properties and stability of the three-dimensional article relative to the same three-dimensional article that is not postcured. In certain embodiments, the article is also subjected to heat or actinic radiation to drive off remaining unreacted components (e.g. reactive diluent) in Step 160.

The following describes general methods for creating a (e.g. clear tray) orthodoncic aligner as printed appliance 300 as a representative 3D printed article. However, other (e.g. dental, orthodontic, and medical) articles can be created using similar techniques with the (e.g. photo)polymerizable compositions described herein. Representative examples include, but are not limited to, the removable appliances having occlusal windows described in International Application Publication No. WO2016/109660 (Raby et al.), the removable appliances with a palatal plate described in US Publication No. 2014/0356799 (Cinader et al); and the resilient polymeric arch members described in International Application Nos. WO2016/148960 and WO2016/149007 (Oda et al.); as well as US Publication No. 2008/0248442 (Cinader et al.); ceramic articles described in International Application Publication Nos. WO2016/191162 (Mayr et al), and molding techniques and tools for forming a dental restoration in a mouth as described in WO2016/094272 (Hansen et al.) and US Publication No. 2019/0083208 (Hansen et al.). Moreover, the photopolymerizable compositions can be used in the creation of indirect bonding trays, such as those described in International Publication No. WO2015/094842 (Paehl et al.) and US Publication No. 2011/0091832 (Kim, et al.) and other dental articles, including but not limited to crowns, bridges, veneers, inlays, onlays, fillings, and prostheses (e.g., partial or full dentures). Other orthodontic appliances and devices include, but not limited to, orthodontic brackets, buccal tubes, lingual retainers, orthodontic bands, class II and class III correctors, sleep apnea devices, bite openers, buttons, cleats, and other attachment devices.

In certain embodiments, the (e.g., orthodontic) article advantageously has a certain equilibrium modulus even after stress relaxation provides a particular maximum amount of stress relaxation. The equilibrium modulus after stress relaxation can be measured by monitoring the stress resulting from a steady strain overtime at a specific temperature (e.g., 37° C.) and a specific relative humidity (e.g., 100% relative humidity). In at least certain embodiments, the equilibrium modulus is 100 MPa or greater after 24 hours at 2% strain under 100% relative humidity and 37° C.

Alternatively, the photopolymerizable compositions can be used in other industries, such as aerospace, animation and entertainment, architecture and art, automotive, consumer goods and packaging, education, electronics, hearing aids, sporting goods, jewelry, medical, manufacturing, etc.

In one embodiment, the depicted in FIG. 3, additive manufactured article 300 is a clear tray aligner. An aligner or other resilient appliance created directly by 3D printing eliminates the need to print a mold of the dental arch and further thermoform the appliance. It also would allow new aligner designs and give more degrees of freedom in the treatment plan. Exemplary methods of direct printing clear tray aligners and other resilient orthodontic apparatuses are set forth in PCT Publication Nos. WO2016/109660 (Raby et al.), WO2016/148960 (Cinader et al.), and WO2016/149007 (Oda et al.) as well as US Publication Nos. US2011/0091832 (Kim, et al.) and US2013/0095446 (Kitching).

The tray aligner is removably positionable over some or all of a patient's teeth. In some embodiments, the appliance 300 is one of a plurality of incremental adjustment appliances. The appliance 300 may comprise a shell having an inner cavity. The inner cavity is shaped to receive and resiliently reposition teeth from one tooth arrangement to a successive tooth arrangement. The inner cavity may include a plurality of receptacles, each of which is adapted to connect to and receive a respective tooth of the patient's dental arch. The receptacles are spaced apart from each other along the length of the cavity, although adjoining regions of adjacent receptacles can be in communication with each other. In some embodiments, the shell fits over all teeth present in the upper jaw or lower jaw. Typically, only certain one(s) of the teeth will be repositioned while others of the teeth will provide a base or anchor region for holding the dental appliance in place as it applies the resilient repositioning force against the tooth or teeth to be treated.

In order to facilitate positioning of the teeth of the patient, at least one of receptacles may be misaligned as compared to the corresponding tooth of the patient. In this manner, the appliance 300 may be configured to apply rotational and/or translational forces to the corresponding tooth of the patient when the appliance 300 is worn by the patient. In some particular examples, the appliance 300 may be configured to provide only compressive or linear forces. In the same or different examples, the appliance 300 may be configured to apply translational forces to one or more of the teeth within receptacles.

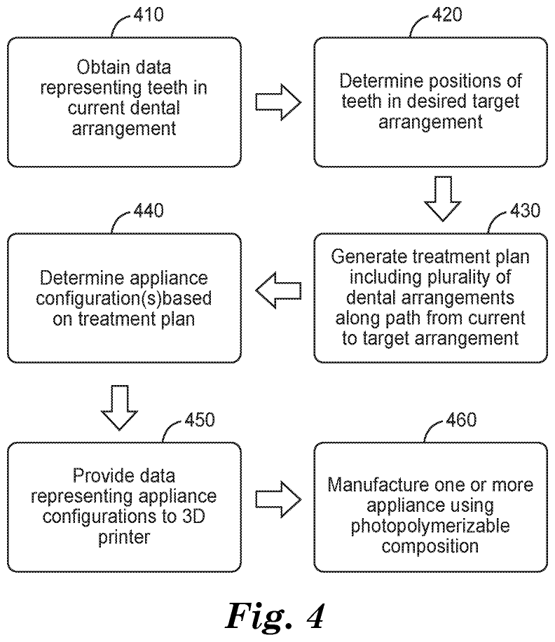

In some embodiments, the shell of the appliance 300 fits over some or all anterior teeth present in an upper jaw or lower jaw. Typically, only certain one(s) of the teeth will be repositioned while others of the teeth will provide a base or anchor region for holding the appliance in place as it applies the resilient repositioning force against the tooth or teeth to be repositioned. An appliance 300 can accordingly be designed such that any receptacle is shaped to facilitate retention of the tooth in a particular position in order to maintain the current position of the tooth. A method 400 of creating an orthodontic appliance using the photopolymerizable compositions of the present disclosure can include general steps as outlined in FIG. 4. Individual aspects of the process are discussed in further detail below. The process includes generating a treatment plan for repositioning a patient's teeth. Briefly, a treatment plan can include obtaining data representing an initial arrangement of the patient's teeth (Step 410), which typically includes obtaining an impression or scan of the patient's teeth prior to the onset of treatment. The treatment plan will also include identifying a final or target arrangement of the patient's anterior and posterior teeth as desired (Step 420), as well as a plurality of planned successive or intermediary tooth arrangements for moving at least the anterior teeth along a treatment path from the initial arrangement toward the selected final or target arrangement (Step 430). One or more appliances can be virtually designed based on the treatment plan (Step 440), and image data representing the appliance designs can exported in STL format, or in any other suitable computer processable format, to an additive manufacturing device (e.g., a 3D printer system) (Step 450). An appliance can be manufactured using a photopolymerizable composition of the present disclosure retained in the additive manufacturing device (Step 460).

In some embodiments, a (e.g., non-transitory) machine-readable medium is employed in additive manufacturing of articles according to at least certain aspects of the present disclosure. Data is typically stored on the machine-readable medium. The data represents a three-dimensional model of an article, which can be accessed by at least one computer processor interfacing with additive manufacturing equipment (e.g., a 3D printer, a manufacturing device, etc.). The data is used to cause the additive manufacturing equipment to create an article comprising a reaction product of a photopolymerizable composition as described herein

Data representing an article may be generated using computer modeling such as computer aided design (CAD) data. Image data representing the (e.g., polymeric) article design can be exported in STL format, or in any other suitable computer processable format, to the additive manufacturing equipment. Scanning methods to scan a three-dimensional object may also be employed to create the data representing the article. One exemplary technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article). In embodiments wherein the article is an orthodontic article, scanning techniques may include, for example, scanning a patient's mouth to customize an orthodontic article for the patient.

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer. A computing device often includes an internal processor, a display (e.g., a monitor), and one or more input devices such as a keyboard and a mouse. The 3D article being produced, such as an aligner may be shown on the display.

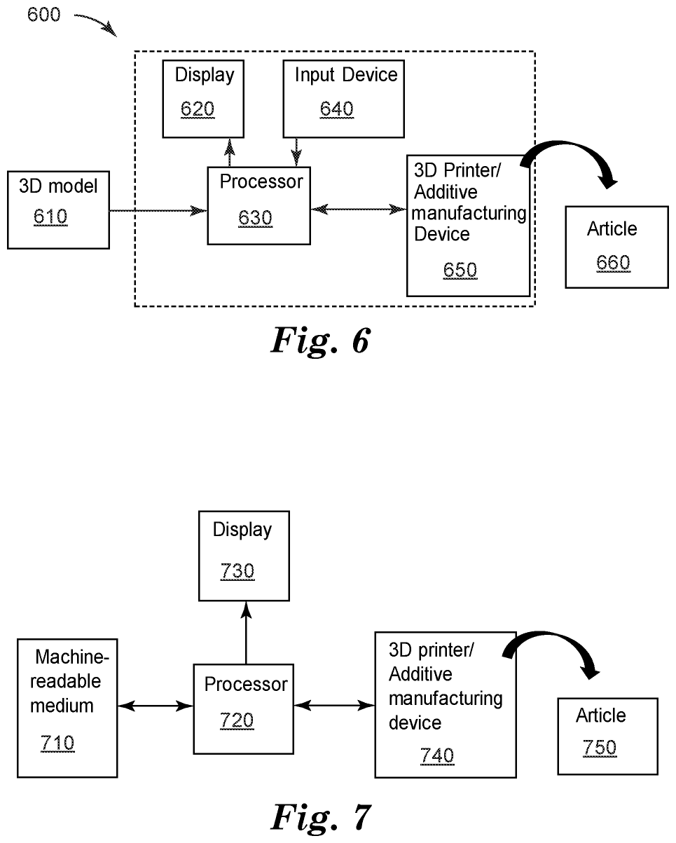

Referring to FIG. 6, in certain embodiments, the present disclosure provides a system 600. The system 600 comprises a display 620 that displays a 3D model 610 of an article (e.g., an aligner 1130 as shown on the display 1100 of FIG. 10); and one or more processors 630 that, in response to the 3D model 610 selected by a user, cause a 3D printer/additive manufacturing device 650 to create a physical object of the article 660. Often, an input device 640 (e.g., keyboard and/or mouse) is employed with the display 620 and the at least one processor 630, particularly for the user to select the 3D model 610. The article 660 comprises a reaction product of a photopolymerizable composition as described herein

Referring to FIG. 7, a processor 720 (or more than one processor) is in communication with each of a machine-readable medium 710 (e.g., a non-transitory medium), a 3D printer/additive manufacturing device 740, and optionally a display 730 for viewing by a user. The 3D printer/additive manufacturing device 740 is configured to make one or more articles 750 based on instructions from the processor 720 providing data representing a 3D model of the article 750 (e.g., an aligner 1130 as shown on the display 1100 of FIG. 10) from the machine-readable medium 710.

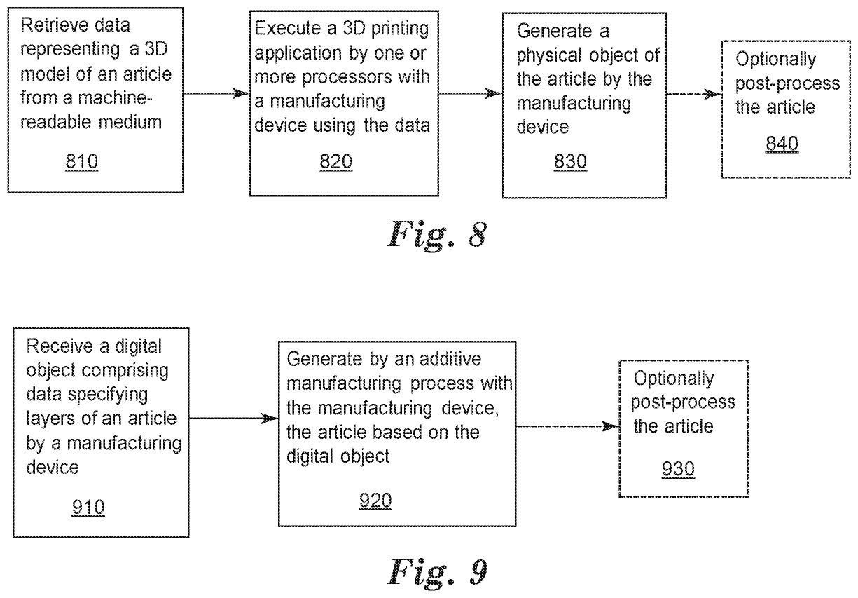

Referring to FIG. 8, for example and without limitation, an additive manufacturing method comprises retrieving 810, from a (e.g., non-transitory) machine-readable medium, data representing a 3D model of an article according to at least one embodiment of the present disclosure. The method further includes executing 820, by one or more processors, an additive manufacturing application interfacing with a manufacturing device using the data; and generating 830, by the manufacturing device, a physical object of the article. The additive manufacturing equipment can selectively cure a photopolymerizable composition, as described herein to form an article. One or more various optional post-processing steps 840 may be undertaken. Referring to FIG. 9, a method of making an article comprises receiving 910, by a manufacturing device having one or more processors, a digital object comprising data specifying a plurality of layers of an article; and generating 920, with the manufacturing device by an additive manufacturing process, the article based on the digital object. Again, the article may undergo one or more steps of post-processing 930, e.g., to cure unpolymerized components remaining in the article. Typically, the manufacturing device selectively cures a photopolymerizable composition, as described herein, to form the article.

Unless stated otherwise, the following terms are defined as follows:
“curing” means the polymerizing a composition by any mechanism, e.g., by heat, light, radiation, e-beam, microwave, chemical reaction, or combinations thereof.
“cured” refers to a material or composition that has been hardened or partially hardened (e.g., polymerized or crosslinked) by curing.
“integral” refers to being made at the same time or being incapable of being separated without damaging one or more of the (integral) parts.
“(meth)acryl” refers to acryl and methacryl which include (meth)acrylate and (meth)acrylamide;
“occlusal” means in a direction toward the outer tips of the patient's teeth; “facial” means in a direction toward the patient's lips or cheeks; and “lingual” means in a direction toward the patient's tongue.

All cited references, patents, and patent applications in the above application for letters patent are herein incorporated by reference in their entirety in a consistent manner. In the event of inconsistencies or contradictions between portions of the incorporated references and this application, the information in the preceding description shall control.

The invention is further described by the following non-limiting examples.

### EXAMPLES

Unless otherwise noted or readily apparent from the context, all parts, percentages, ratios, etc. in the Examples and the rest of the specification are by weight.

### Materials Used in the Examples

| Material designation | Description |
|---|---|
| DCM | Dichloromethane (HPLC grade from Fisher Scientific, Waltham, MA), |
| | dried over calcium hydride and distilled prior to use. |
| EtOAc | Ethyl acetate (ACS grade from Fisher Scientific). Used as received. |
| IPA | Isopropanol (ACS grade from Fisher Scientific). Used as received |
| Propylene carbonate | 1,2-Propanediol cyclic carbonate (reagent grade from Millipore |
| | Sigma, Burlington, MA). Used as received. |
| Methanol | Methanol (ACS grade from Fisher Scientific). Used as received. |
| IPDA | 3-Aminomethyl-3,5,5-trimethylcyclohexylamine (isophorone |
| | diamine), mixture of stereoisomers from Oakwood Products, Inc, |
| | Estill, South Carolina. Used as received. |
| HDA | 1,6-Hexanediamine (98%) from Sigma Aldrich, St. Louis, MO. Used |
| | as received. |
| BTFEO | Bis(2,2,2-trifluoroethyl) oxalate, prepared according to |
| | US2012/271025. Supplied by 3M Materials Resource Division. Used |
| | as received. |
| C2-OXLYAMINO-TFA | Bis(2,2,2-trifluoroethyl) 2,2′-(ethane-1,2-diylbis(azanediyl))bis(2- |
| | oxoacetate) synthesized from bis(2,2,2-trifluoroethyl) oxalate and |
| | ethylene diamine, according to the procedure in US2012/271025. |
| | Supplied by 3M Materials Resource Division. Used as received. |
| TFE | 2,2,2-Trifluoroethanol, >99% from Sigma Aldrich. Used as received. |
| BASIC ALUMINA | Activated aluminum oxide, Basic, Brockmann 1, from Sigma Aldrich. |
| | Used as received. |
| DBU | 1,8-Diazabicyclo[5.4.0]undec-7-ene (98%), from Sigma Aldrich. Used |
| | as received |
| HEMA | 2-Hydroxyethyl methacrylate (97%) stabilized, Acros Organics, Fair |
| | Lawn, NJ. Used as received. |
| C2050R | A polycarbonate diol of about 2000 MW made with 3-methyl-1,5- |
| | pentanediol (MPD) and hexane diol (HD) obtained as “KURARAY |
| | POLYOL C2050R” from Kuraray Co. Ltd., Tokyo, Japan. Used as |
| | received. |
| P2010 | A polyester diol of about 2000 MW made with 3-methyl-1,5- |
| | pentanediol (MPD) and adipate obtained as “KURARAY POLYOL P- |
| | 2010” from Kuraray Co. Ltd. Used as received. |
| HLBH P3000 | A polyolefin diol of about 3000 MW made from hydrogenation of |
| | poly(butadiene) diol. Obtained as “KRASOL ® HLBH P 3000” From |
| | Cray Valley, Paris, France. Used as received. |
| PTHF1000 | Poly(tetrahydrofuran) diol of about 1000 MW. Obtained as |
| | ‘PolyTHF1000’ from BASF, Ludwigshafen, Germany. Used as |
| | received. |
| IBOMA | Isobornyl acrylate obtained as “SR423A” from Sartomer, Exton, PA. |
| | Used as received. |
| BHT | 2,6-di-t-butyl-4-methylphenol (99%) (butylated hydroxy toluene), |
| | obtained from Alfa Aesar, Haverhill, MA. Used as received. |
| TPO | 2,4,6-trimethylbenzoyldiphenylphosphine oxide photoinitiator |
| | obtained as “IRGACURE TPO” from BASF, Wyandotte, MI. Used as |
| | received. |
| Tinuvin 326 | 2-(5-chloro-2H-benzotriazol-2-yl)-6-(1,1-dimethylethyl)-4-methy |
| | phenol, a UVL light absorber of the hydroxyphenyl benzotriazole |
| | class, obtained as Tinuvin 326 from BASF, Wyandotte, MI. Used as |
| | received. |
| Synfac 8024U | A bisphenol-a derived poly(ether) diol of about 360 MW. Obtained as |
| | ‘Synfac8024U’ from Milliken Chemical, Spartanburg, South Carolina. |
| Glycerol dimethacrylate | Mixture of 1,2 and 1,3 isomers (>90% purity) stabilized with MEHQ. |
| | Obtained from TCI America, Portland, OR. Used as received. |
| IEM | 1-isocyanatoethyl methacrylate (98%) obtained from Millipore Sigma, |
| | Burlington, MA, used as received. |
| DBTDL | Dibutyltin dilaurate (95%) from Millipore Sigma, Burlington, MA, |
| | used as received. |
| methacryloyl chloride | Methacryloyl chloride (97%) from Millipore Sigma, Burlington, MA, |
| | used as received. |
| Methacrylic anhydride | Methacrylic anhydride (94%) from Millipore Sigma, Burlington, MA, |
| | used as received. |
| TEA | Triethylammine (99.7%) from Acros Organics. Obtained from Fisher |
| | Scientific, Waltham, MA. Dried over potassium hydroxide and |
| | distilled prior to use. |
| Pyridine | Pyridine (ACS grade) from Fisher Scientific, Waltham, MA. Used as |
| | received. |
| 3-methyl-1,5-pentane | 3-methyl-1,5-pentane diol (98%) Millipore Sigma, Burlington, MA, |
| diol | used as received. |
| Oxalyl chloride | Oxalyl chloride (>99%) Millipore Sigma, Burlington, MA, used as |
| | received. |

### Test Methods

Tensile and thermal properties of polymers from cast resin formulations To create samples for mechanical testing and DSC analysis, the formulated resin mixtures were poured into a silicone dogbone mold (Type V mold of 1 mm thickness, ASTM D638-14). The filled mold was placed between two glass plates and cured in an Asiga Pico Flash post-curing device (Sydney, Australia) for 30 minutes, while passing nitrogen through the chamber during the cure. The sample was demolded and cured for another 30 minutes in the chamber, again passing nitrogen through the chamber. The samples were kept in a vacuum oven set to 100° C. overnight to remove any residual unreacted monomer. One sample was removed and used for extraction tests with dichloromethane (DCM) to determine the gel content before and after this post treatment. The tensile strength was determined by uniaxial extension at a displacement rate of 5 mm min⁻¹ according to ASTM D638-14 using an MTS Criterion Model 43 (MTS, Eden Prairie, MN) instrument equipped with a 2 kN load cell. The data were analyzed using MTS TESTSUITE TW Elite Software.
3D Printing of Objects The formulation of Example 4 was photopolymerized on an Asiga Max X printer with an LED light source of 385 nm. Stereolithography files (STL) of the ASTM D638 dog-bone (type V) and rectangular bars [9.53 mm×25.43 mm×1 mm] for dynamic mechanical analysis (DMA) testing were loaded into the software and support structures were generated. The resin bath of the printer was heated to 35° C. before photopolymerization to reduce the viscosity. The following settings were used: Slice thickness=50 micrometers, Burn-In Layers=1, Separation Velocity=10 mm/s, Slides per Layer=1, Burn-In Exposure Time=20.0 s, Normal Exposure Time=7 s. After 8 hours printing time, the photopolymerized objects were then cleaned in propylene carbonate and IPA to remove unreacted resin, dabbed dry with a paper towel, and then post-cured with an Asiga Pico Flash post-curing device for 2×30 minutes each side. Finally, the printed objects were baked in a vacuum set to 100° C. for 8 hours to remove any unreacted monomers.
Size Exclusion Chromatography: Molar masses were determined on a Waters e2695 separations module GPC equipped with 2414 RI and 2489 UV Vis detectors. The separations were conducted using a Styragel Guard Column, 20 μm, 4.6 mm×30 mm in combination with Styragel Column, HR 5E, mixed bed, 5 μm, 7.8 mm×300 mm, 2K−4M). Sample was passed through the columns at a flow rate of 0.7 ml min⁻¹ using a THF mobile phase. Data were processed in Empower software and molar masses are reported relative to polystyrene standards.
Differential Scanning Calorimetry: Thermal properties of cast and photocured resin samplewere measured on a Discovery DSC2500 and results were analyzed using Trios software. Typically a small piece of material was cut from the grips of the dog bone or from the flash from the mold for analysis. Samples were prepared in hermetically sealed pans and the samples were equilibrated at 20° C. before heating to 180° C. at 10° C. min⁻¹ and annealing for 1 minute to clear the thermal history before cooling to −70° C., then re-heating to 180° C. at the same rate. The results are reported for the second heating ramp.

### Prepartory Example 1: Ipda-Oxlyamino Compound

Oxylamino precursors were synthesized using the procedures previously outlined in WO2011/8269A1. Specifically, BTFEO (153 g, 0.6 mols) and TFE (120 ml, 159 g, 1.59 mols) were combined in a round-bottom flask and cooled to −10° C. Separately, TFE (30 ml, 39.75 g, 0.397 mol) and IPDA (11 ml, 10.1 g, 0.06 mols) were mixed. The IPDA solution was added dropwise over the course of 2 hours to the BTFEO solution while stirring. The reaction was then warmed to room temperature overnight. TFE was removed by rotary evaporation, and subsequently the excess BTFEO was recovered by distilling off the reaction under high vacuum at 100° C. The IPDA-oxylamino was purified by column chromatography (silica with a DCM/Methanol mobile phase (0-5% gradient)) to isolate IPDA-Oxylamino (17 g, 61% yield) from oligomeric byproducts.

### Preparatory Example 2: Hda-Oxylamino Compound

Oxylamino precursors were synthesized using the procedures previously outlined in WO2011/8269A1. Specifically, hexamethylene diamine (HDA) (10.3 g, 0.0886 moles) was melted and mixed with TFE (43 ml, 58.9 g, 0.587 moles). Separately BTFEO (218 g, 0.858 moles) was added to TFE (175 ml, 240 g, 2.40 moles) and the solution cooled in a −10° C. salt/ice bath. The HDA solution was added dropwise to the cooled flask by addition funnel. The reaction was allowed to stir on ice for 2 hours, then warmed to room temperature and stirred overnight. The residual TFE was removed by rotary evaporation and the excess BTFEO recovered by distilling off the reaction under high vacuum. The product was purified by column chromatography (silica with an ethyl acetate mobile phase to isolate (C6)-Oxylamino-TFA (25 g, 0.0589 mol, 70% yield) from oligomeric byproducts.

### Example 3: Synthesis of Dicarbonyl Polymer Prepared from Poly(Carbonate) Diol

IPDA-Oxylamino with trifluoroethanol leaving group (15 g, 0.031 mol) and pre-dried C2050R polyol (30 g, 0.01532 mol) were dissolved in 100 ml DCM (dry) in a round bottom flask with septum. When fully dissolved, DBU (0.3 ml) was injected, and the reaction was run at room temperature for 3 hours. At this time, an aliquot was removed and ¹H NMR analysis was used to confirm end-functionalization of the polycarbonate with oxylamino. Next, 7.5 m1 HEMA (7.0 g, 0.05 moles) were injected and the reaction stirred overnight at room temperature. The reaction was then diluted with 400 ml DCM and passed through a plug of basic alumina to remove residual HEMA, flushing with an additional 400 ml DCM. The solvent was removed by rotary evaporation and dried on a high vacuum line to yield 41.0 grams (84%) of the depicted reaction product). Measured molar mass by size exclusion chromatography (SEC) and reported relative to polystyrene standards: Mₙ=8900 g mol⁻¹, M_{W}/M_{N}=1.74.

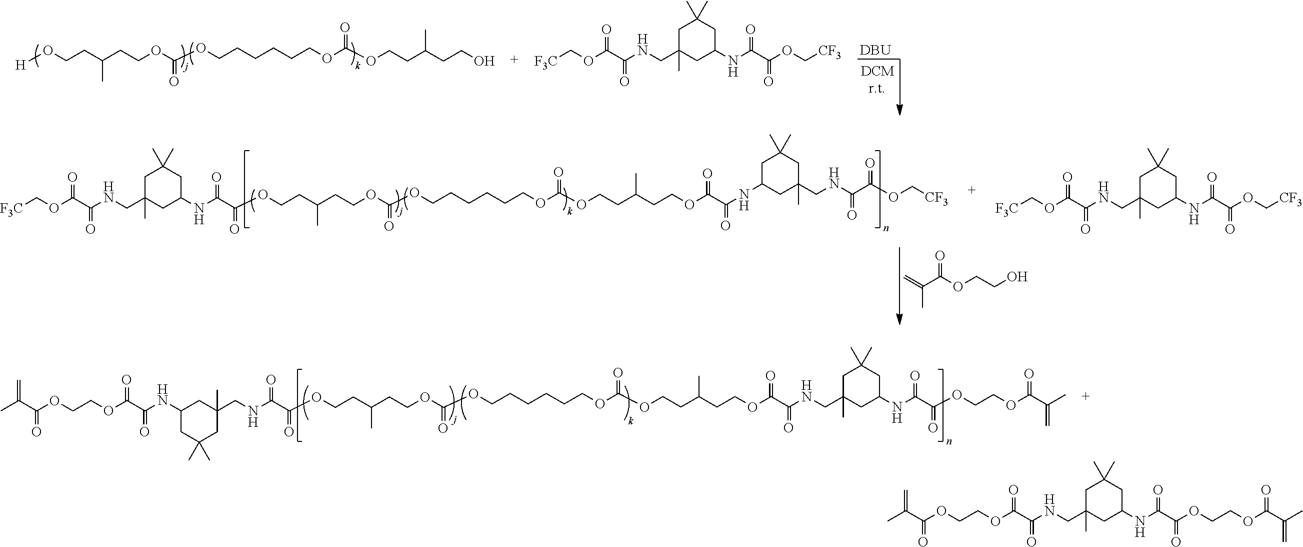

### Example 4: Preparation of Photopolymerizable Resin from Dicarbonyl Polymer of Example 3

First 1.49 g TPO (2%), 20 mg BHT (0.025%), and 20 mg Tinuvin 326 (0.025%) were dissolved in 35 m1 IBOMA (45%). When fully dissolved, the IBOMA solution was added to a flask containing 41 g dried Dicarbonyl Polymer of Example 3. The resin formulation was mixed using a magnetic stirrer overnight before use and stored in a refrigerator at 4° C. when not in use. Observed T_{g} value of crosslinked cast resin determined by differential scanning calorimetry (DSC): T_{g1}=−57.6° C. T_{g2}=Not observed.

TABLE 1
Tensile Results on cast samples (reported as
average and standard deviation of 5 bars):

| E | σ_{B} | | | |
|---|---|---|---|---|
| Young's | Tensile | ε_{B} | σ_{y} | |
| Tensile Elastic | Strength at | Elongation | Tensile Strength | ε_{y} |
| Modulus | break | at break | at Yield | Yield Strain |
| (MPa) | (MPa) | (%) | (MPa) | (%) |
| 720 ± 30 | 19 ± 3 | 50 ± 20 | 17.9 ± 0.4 | 5.2 ± 0.3 |

### Example 5: Synthesis of Dicarbonyl Polymer Prepared from Poly(Ether) Diol

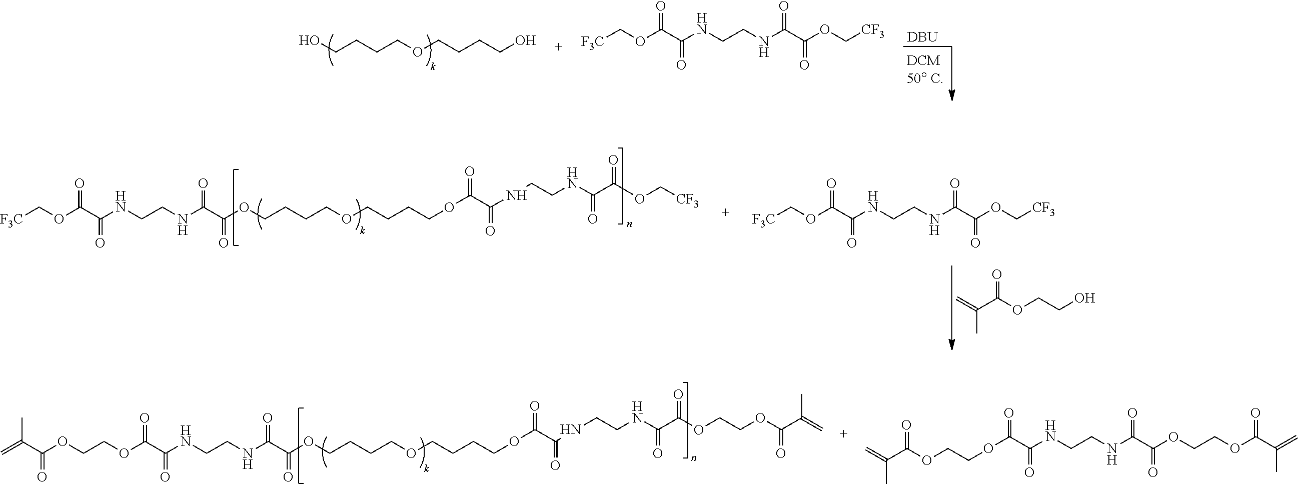

C2-Oxylamino with trifluoroethanol leaving group was prepared in the same manner as Preparatory Examples 1 and 2. C2-Oxylamino with trifluoroethanol leaving group (7.5 g, 0.020 mol) and pre-dried PTHF1000 polyol (10.5 g, 0.0105 mol) were added to 250 ml DCM (dry) in a dry 500 ml round bottom flask and the reaction capped with a septum. DBU (20 microliters, 20 mg, 0.13 mmol) was injected, and the reaction was run at room temperature overnight. Then the septum was replaced with a reflux condenser and the reaction was heated to 50° C. under nitrogen for 24 hours. After cooling to room temperature, residual solids were filtered off. The solvent was removed by rotary evaporation and the crude sample analyzed by ¹H NMR. The sample was then re-dissolved in dry DCM and HEMA (4.0 ml, 4.2 g, 0.03 moles) and DBU (20 microliters, 20 mg, 0.13 mmol were injected and the reaction stirred at room temperature for 72 hours. The reaction passed through a plug of basic alumina to remove residual HEMA and trifluoroethanol, flushing with an additional 400 ml DCM. The solvent was removed by rotary evaporation and dried on a high vacuum line to yield 15.0 grams (89%) of the depicted reaction product. Measured molar mass by size exclusion chromatography (SEC) and reported relative to polystyrene standards Mₙ=2600 g mol⁻¹, M_{W}/M_{N}=1.65.

### Example 6: Preparation of Photopolymerizable Resin from Dicarbonyl Polymer of Example 5

First 0.53 g TPO (2 wt %), 7 mg BHT (0.025 wt %), and 7 mg Tinuvin 326 (0.025 wt %) were dissolved in IBOMA (12 g, 45 wt %). When fully dissolved, the IBOMA solution was added to a flask containing 15.0 g dried Dicarbonyl Polymer of Example 5. The resin formulation was mixed using a magnetic stirrer overnight before use and stored in a refrigerator at 4° C. when not in use. Observed T_{g} value of cast and crosslinked resin determined by differential scanning calorimetry (DSC): T_{g1}=−46.5° C. T_{g2}=22.1° C.

### Example 7: Synthesis of Dicarbonyl Polymer Prepared from Poly(Ester) Diol

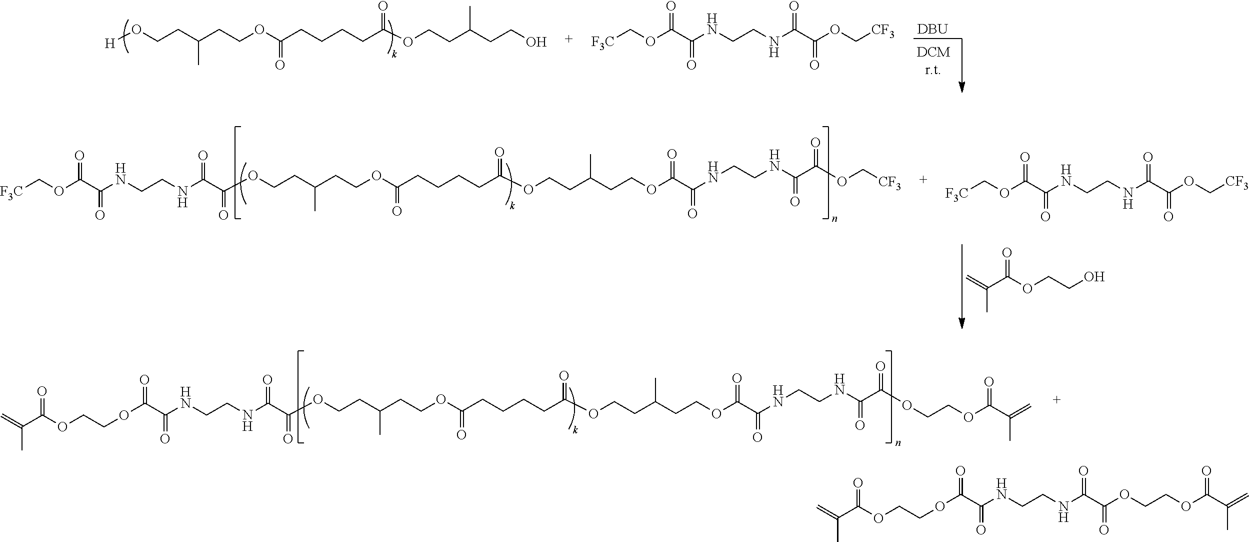

C2-OXYLAMINO (10.14 g, 0.027 mol) and pre-dried P2010 polyol (13.68 g, 0.00676 mol) were added to 250 ml DCM (dry) in a dry 500 ml round bottom flask and the reaction capped with a septum. DBU (50 microliters, 50 mg, 0.33 mmol was injected, and the reaction was run at room temperature overnight. Then residual solids were filtered off. The solvent was removed by rotary evaporation and the crude sample analyzed by ¹H NMR. The sample was then re-dissolved in dry DCM and HEMA (2.5 ml, 2.7 g, 0.021 moles) and DBU (50 microliters, 50 mg, 0.33 mmol) was injected and the reaction stirred at room temperature for 72 hours. The reaction was passed through a plug of basic alumina to remove residual HEMA and trifluoroethanol, flushing with an additional 200 ml DCM. The solvent was removed by rotary evaporation and dried on a high vacuum line to yield 7.38 grams (41%) of the depicted reaction product. Measured molar mass by size exclusion chromatography (SEC) and reported relative to polystyrene standards Mₙ=2630 g mol⁻¹, M_{W}/M_{N}=2.36.

### Example 8: Preparation of Photopolymerizable Resin from Dicarbonyl Polymer of Example 7

First 0.27 g TPO (2 wt %), 3 mg BHT (0.025 wt %), and 3 mg Tinuvin 326 (0.025 wt %) were dissolved in IBOMA (6.1 g, 45 wt %). When fully dissolved, the IBOMA solution was added to a flask containing 7.38 g dried Dicarbonyl Polymer of Example 7. The resin formulation was mixed using a magnetic stirrer overnight before use and stored in a refrigerator at 4° C. when not in use. Observed T_{g} value of crosslinked resin determined by differential scanning calorimetry (DSC): T_{g1}=−42.8° C. T_{g2}=Not observed.

### Example 9: Synthesis of Dicarbonyl Polymer Prepared from Poly(Olefin) Diol

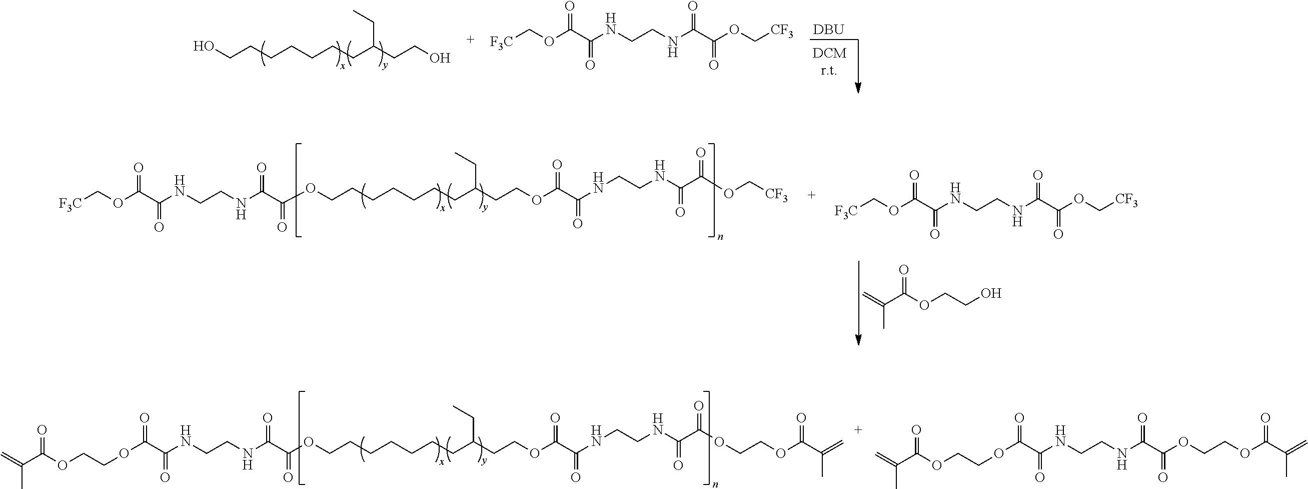

C2-OXYLAMINO (5.05 g, 0.0137 mol) and pre-dried HLBH P3000 polyol (10.1 g, 0.00325 mol) were added to 250 ml DCM (dry) in a dry 500 ml round bottom flask and the reaction capped with a septum. DBU (50 microliters, 50 mg, 0.33 mmol) was injected, and the reaction was run at room temperature overnight. Then residual solids were filtered off. The solvent was removed by rotary evaporation and the crude sample analyzed by ¹H NMR. The sample was then re-dissolved in dry DCM and HEMA (1.2 ml, 1.3 g, 0.0098 moles) and DBU (50 microliters, 50 mg, 0.33 mmol) was injected and the reaction stirred at room temperature for 72 hours. The reaction passed through a plug of basic alumina to remove residual HEMA and trifluoroethanol, flushing with an additional 200 ml DCM. The solvent was removed by rotary evaporation and dried on a high vacuum line to yield 10.68 grams (88%) of the depicted reaction products. Measured molar mass by size exclusion chromatography (SEC) and reported relative to polystyrene standards Mₙ=5160 g mol⁻¹, M_{W}/M_{N}=1.20.

### Example 10: Preparation of Photopolymerizable Resin from Dicarbonyl Polymer of Example 9

First 0.393 g TPO (2 wt %), 5 mg BHT (0.025 wt %), and 5 mg Tinuvin 326 (0.025 wt %) were dissolved in IBOMA (8.97 g, 45 wt %). When fully dissolved, the IBOMA solution was added to a flask containing 10.68 g dried Dicarbonyl Polymer of Example 9. The resin formulation was mixed using a magnetic stirrer overnight before use and stored in a refrigerator at 4° C. when not in use. Observed T_{g} value of crosslinked resin determined by differential scanning calorimetry (DSC): T_{g1}=−47.8° C. T_{g2}=Not observed.

### Example 11: Example Synthesis of Dicarbonyl Polymer Prepared from Poly(Olefin) Diol

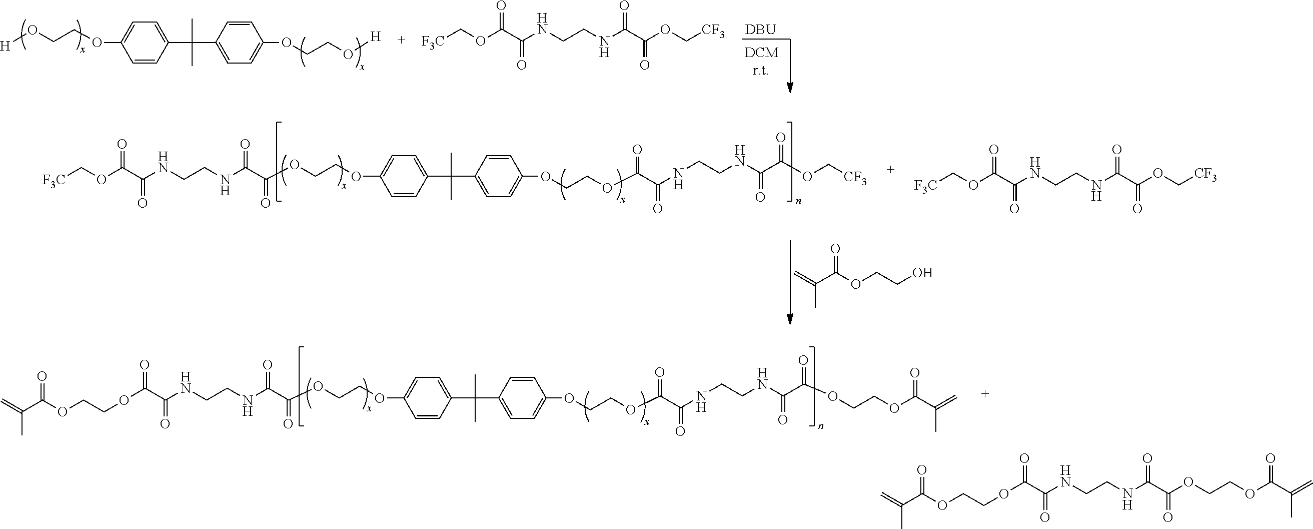

C2-OXYLAMINO (10.7 g, 0.029 mol) and pre-dried Synfac 8024U polyol (2.6 g, 0.0072 mol) were added to 150 ml DCM (dry) in a dry 250 ml round bottom flask and the reaction capped with a septum. DBU (50 microliters, 50 mg, 0.33 mmol) was injected, and the reaction was run at room temperature overnight. Then residual solids were filtered off. The solvent was removed by rotary evaporation and the crude sample analyzed by ¹H NMR. The sample was then re-dissolved in dry DCM and HEMA (7.5 ml, 8.02 g, 0.062 moles) and DBU (50 microliters, 50 mg, 0.33 mmol) was injected and the reaction stirred at room temperature for 72 hours. The reaction passed through a plug of basic alumina to remove residual HEMA and trifluoroethanol, flushing with an additional 200 ml DCM. The solvent was removed by rotary evaporation and dried on a high vacuum line to yield 4.9 grams (70%) of the depicted reaction products.

### Example 12: Synthesis of Dicarbonyl Polymer Prepared from Poly(Carbonate) Diol Having a Multifunctional End Group

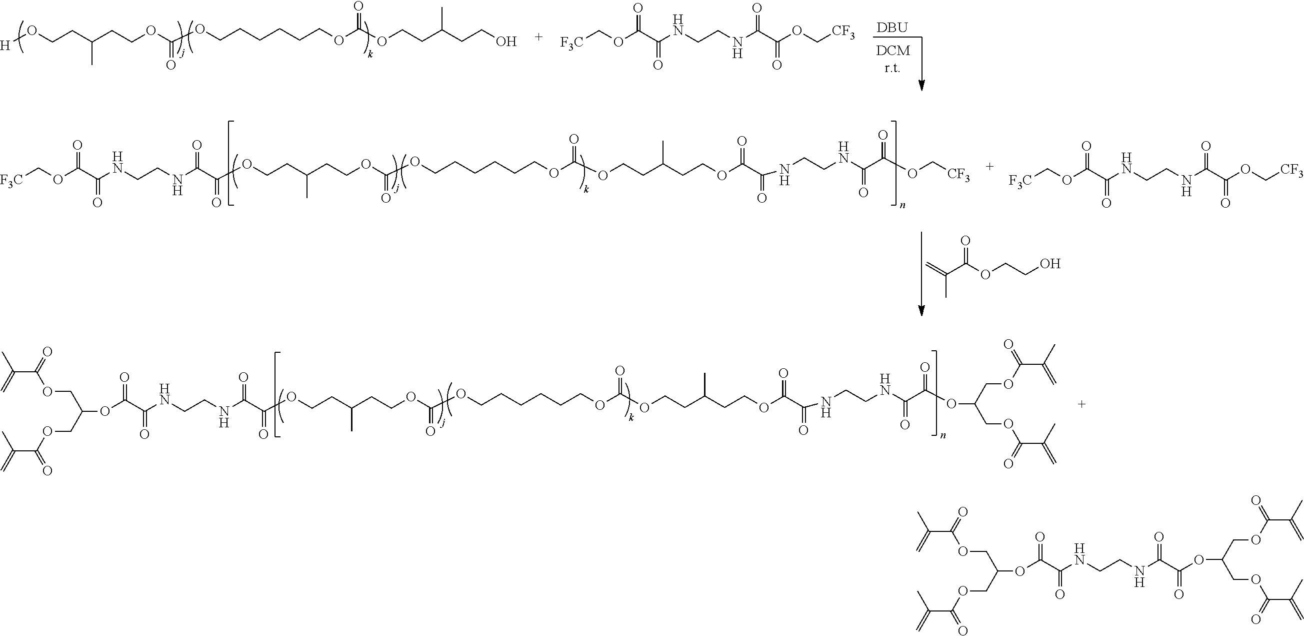

C2-OXYLAMINO (7.5 g, 0.0203 mol) and pre-dried C2050C polyol (11.3 g, 0.00563 mol) were added to 250 ml DCM (dry) in a dry 500 ml round bottom flask and the reaction capped with a septum. DBU (50 microliters, 50 mg, 0.33 mmol was injected, and the reaction was run at room temperature overnight. Then residual solids were filtered off. The solvent was removed by rotary evaporation and the crude sample analyzed by ¹H NMR. The sample was then re-dissolved in dry DCM and glycerol dimethacrylate (13.7 g, 0.060 moles) and DBU (50 microliters, 50 mg, 0.33 mmol) was injected and the reaction stirred at room temperature for 72 hours. The reaction was passed through a plug of basic alumina to remove residual glycerol dimethacrylate and trifluoroethanol, flushing with an additional 200 ml DCM. The solvent was removed by rotary evaporation and dried on a high vacuum line to yield 11.1 grams (70%) of the depicted reaction products. Measured molar mass by size exclusion chromatography (SEC) and reported relative to polystyrene standards Mₙ32 11500, M_{W}/M_{N}=1.75.

### Example 13: Proposed Synthesis of Dicarbonyl Polymer Prepared from Poly(Ether) Diol

C6-OXYLAMINO (lequivalent) and pre-dried PTHF polyol (2 equivalents) will be added DCM (dry) in a dry round bottom flask and the reaction capped with a septum. DBU (catalytic) will be injected, and the reaction will be left at room temperature overnight. The solvent will be removed by rotary evaporation and the crude sample analyzed by ¹H NMR. The sample will be then re-dissolved in dry DCM and 2-isocyanatoethyl methacrylate (IEM) (2.1 equivalents) and dibutyltin dilaurate (DBTDL) (catalytic) will be injected and the reaction stirred at room temperature for 48 hours. The reaction will then be passed through a plug of silica to remove residual catalyst and trifluoroethanol, flushing with additional DCM. The solvent will be removed by rotary evaporation and dried on a high vacuum line to yield the depicted reaction products.

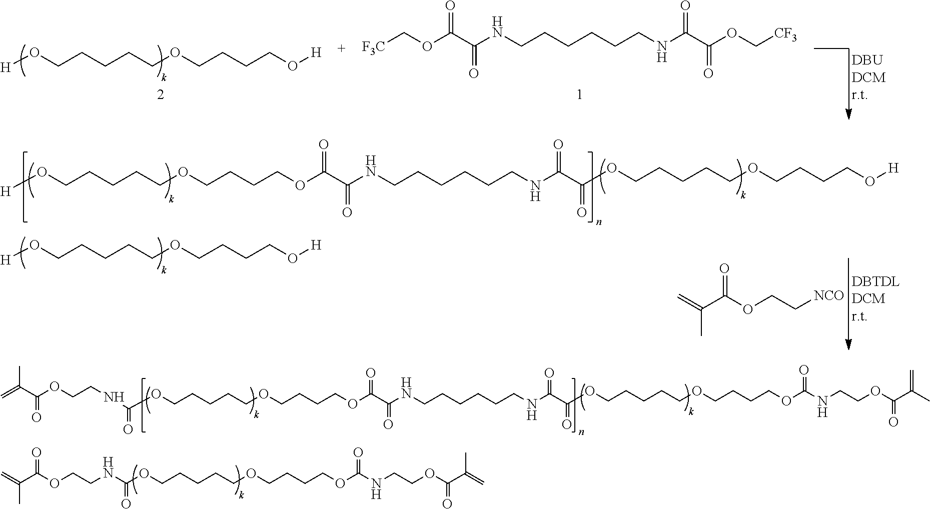

### Example 14: Proposed Synthesis of Dicarbonyl Polymer Prepared from Poly(Ether) Diol

C6-OXYLAMINO (1 equivalent) and pre-dried PTHF polyol (2 equivalents) will be added to DCM (dry) in a dry round bottom flask and the reaction capped with a septum. DBU (catalytic) will be injected, and the reaction will be left at room temperature overnight. The solvent will be removed by rotary evaporation and the crude sample analyzed by ¹H NMR. The sample will be then re-dissolved in dry DCM, cooled to −10° C. in an ice/salt bath and triethyl amine (TEA) (2.2 equivalents) added. Next, methacryloyl chloride (2.2 equivalents) will be injected and the reaction stirred at −10° C. and allowed to warm to room temperature overnight. The reaction will then be filtered to remove the TEA/HCl salt and further purified by washing with water. The organic layer will be dried, then filtered and further purified by passing through a silica plug if necessary. Finally, the solvent will be removed by rotary evaporation and dried on a high vacuum line to yield the depicted reaction products.

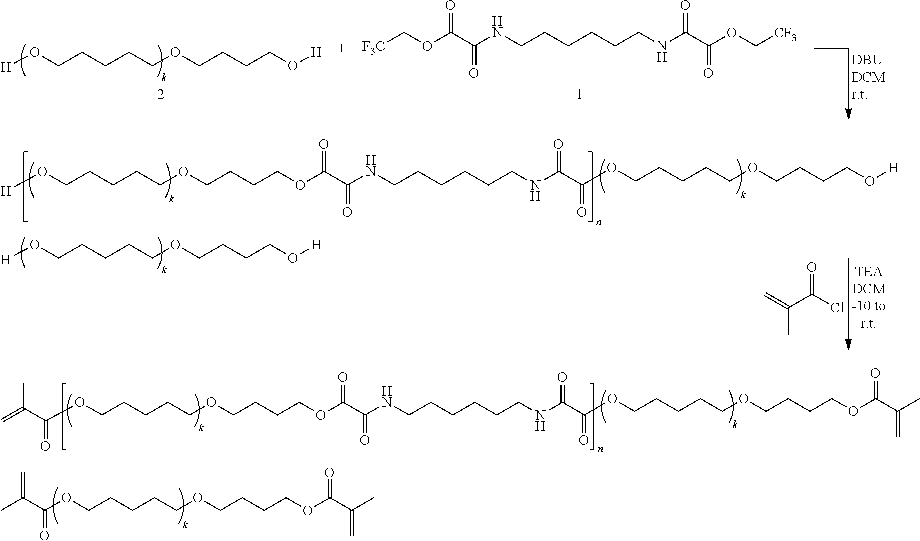

### Example 15: Proposed Synthesis of Dicarbonyl Polymer Prepared from Poly(Ether) Diol

C6-OXYLAMINO (1 equivalent) and pre-dried PTHF polyol (23.4 g, 0.0235 mol) will be added to DCM (dry) in a dry round bottom flask and the reaction capped with a septum. DBU (catalytic) will be injected, and the reaction will be left at room temperature overnight. The solvent will be removed by rotary evaporation and the crude sample analyzed by ¹H NMR. The sample will be then re-dissolved in dry DCM and pyridine (catalytic) and methacrylic anhydride (2.2 equivalents) will be injected and the reaction stirred at room temperature. The reaction will be purified by washing with water. The organic layer will be dried, then filtered and further purified by passing through a silica plug if necessary. Finally, the solvent will be removed by rotary evaporation and dried on a high vacuum line to yield the depicted reaction products. The dicarbonyl polymers described herein can be tested according to the methods described herein. Photopolymerizable compositions can be prepared from the dicarbonyl polymers as described herein. The photopolymerizable resins and cured resin can also be tested according to the test methods described herein.

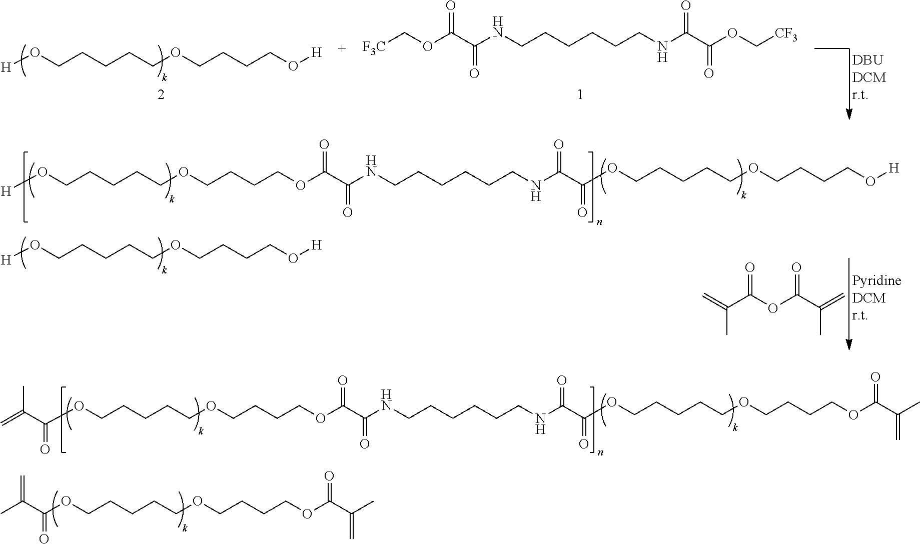

### Example 16: Proposed Synthesis of Dicarbonyl Polymer with Oxalate Groups Prepared from Poly(Ether) Diol

Pre-dried PTHF polyol (1 eq) will be added to DCM in a dry round bottom flask with TEA (2 equivalents) and cooled to −10 C. Next, oxalyl chloride (2 equivalents) will be added to generate the oxyl-terminated polymer in situ. After this, 3-Methyl-1,5 pentane diol (1 equivalent) will be added. The reaction will then be warmed to room temperature, and the TEA/HCl salts removed by filtration and washing to isolate the alcohol terminated polymer. The alcohol-terminated polymer will be dried and dissolved in DCM and IEA (1.05 equivalents) will be added to generate the methacrylate-terminated polymer.

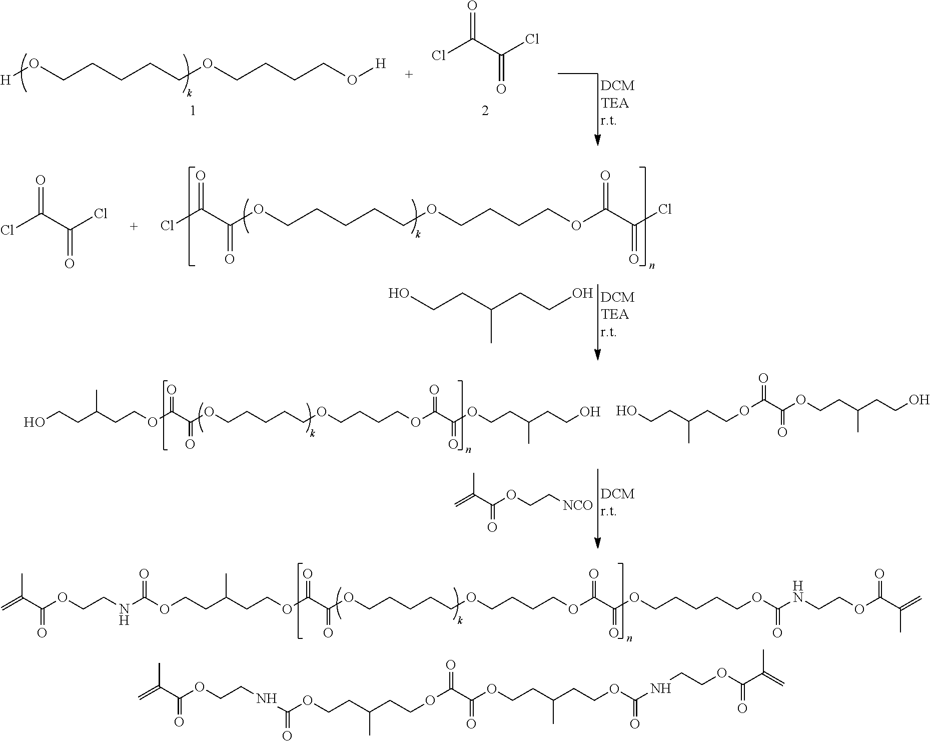

1. An orthodontic article comprising the reaction product of free-radically polymerizable resin comprising:
at least one dicarbonyl polymer comprising polymerized units of oxamate, oxalate, or a combination thereof and at least two free-radically polymerizable groups.

2. The orthodontic article of claim 1 wherein the free-radically polymerizable resin comprises greater than 10, 15, 20, 25, or 30 wt. % of the polymer.

3. The orthodontic article of claim 1 wherein the dicarbonyl polymer comprises at least 3, 4, 5, 6, 7, 8, 9, or 10 polymerized units of oxamate, oxalate, or a combination thereof.

4. The orthodontic article of claim 1 wherein the dicarbonyl polymer has a number average molecular weight ranging from 500 g/mole to 25,000 g/mole.

5. The orthodontic article of claim 1 wherein the dicarbonyl polymer comprises polymerized units of a polymeric polyol selected from polycarbonate diol, polyester diol, polyether diol, polyolefin diol, or a combination thereof.

6. The orthodontic article of claim 5 wherein the polymeric polyol has a Mn of at least 325, 350, 400, 450, 500, 550, 600, 650, 700, 500, 750, 1000, 1250, 1500, 1750, 2000, 2250, 2500, 2750, or 3000 g/mole.

7. The orthodontic article of claim 1 wherein the reaction product further comprises products that are the reaction product of a polymeric diol, oxylamino, or oxylate compounds and a coreactant comprising a free-radically polymerizable group.

8. The orthodontic article of claim 1 wherein the reaction product has one or more glass transitions temperatures (Tgs).

9. The orthodontic article of claim 8 wherein the reaction product has a Tg less than 0, −10, −25, −30, −35, −40, −45, −55, −55, −60, or −65° C.

10. The orthodontic article of claim 1 wherein the polymerizable composition further comprises at least one free-radically polymerizable component having a Tg greater than the polymer and/or having a molecular weight less than the dicarbonyl polymer.

11. The orthodontic article of claim 10 wherein the free-radically polymerizable component is a monofunctional (meth)acrylate monomer having a Tg of at least 25, 30, 35, 40, 45, 50, 60, 65, 70, 75, 80, 85, 90, 100, 110, 115, 120, 125, 130, 135, 140, 145, or 150° C.

12. The orthodontic article of claim 1 wherein the free-radically polymerizable resin comprises no greater than 35 wt. % of free-radically polymerizable component having a high affinity for water.

13. (canceled)

14. The orthodontic article of claim 1 wherein the dicarbonyl polymer comprises repeat units having the formula: 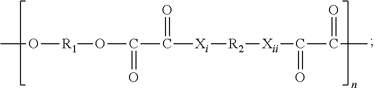
wherein
each —O—R₁—O— is independently a polymerized unit of a polymeric polyol;
Xi and Xii are independently O or NR³ wherein R³ is H or an organic group;
each R₂ is independently a divalent organic group; and
n is at least 1, 2, 3, 4, 5, 6, 7, 8, 9, or 10.

15. The orthodontic article of claim 1 wherein the dicarbonyl polymer has the formula 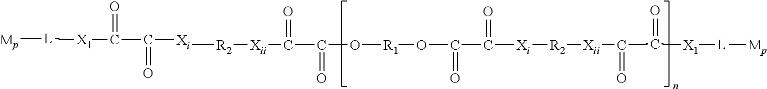
wherein
each —O—R₁—O— is independently a polymerized unit of a polymeric polyol;
X₁, Xi and Xii are independently O or NR³ wherein R³ is H or an organic group;
each R₂ is independently an organic group;
n is at least 1, 2, 3, 4, 5, 6, 7, 8, 9, or 10;
L is a polyvalent linking group;
Mp is a free radical polymerizable group; and
p ranges from 1 to 3.

16. The orthodontic article of claim 1 wherein the dicarbonyl polymer has the general formula 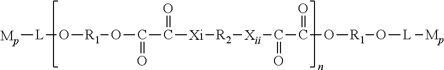
wherein
each —O—R₁—O— is independently a polymerized unit of a polymeric polyol;
Xi and Xii are independently O or NR³ wherein R³ is H or an organic group;
each R₂ is independently ant organic group;
n is at least 1, 2, 3, 4, 5, 6, 7, 8, 9, or 10;
L is a polyvalent linking group;
Mp is a free radical polymerizable group; and
p ranges from 1 to 3.

17. The orthodontic article of claim 1 wherein the orthodontic article is an orthodontic tray aligner article.

18-29. (canceled)

30. A method comprising:
receiving, by a manufacturing device having one or more processors, a digital object comprising data specifying a plurality of layers of an orthodontic article; and
generating, with the manufacturing device by an additive manufacturing process, the orthodontic article based on the digital object, the orthodontic article comprising a reaction product of a polymerizable composition comprising:
at least one dicarbonyl polymer comprising polymerized units of oxamate, oxalate, or a combination thereof and at least two free-radically polymerizable groups.

31. (canceled)

32. (canceled)

33. A method of preparing a dicarbonyl polymer comprising:
reacting a polymeric diol with an oxylamino or oxylate compound comprising haloalkyl end groups; and reacting the haloalkyl end groups with a coreactant further comprising at least one free-radically polymerizable group.

34. A method of claim 33 further comprising reacting the haloalkyl end groups with a diol compound prior to reaction with the coreactant further comprising at least one free-radically polymerizable group.

35. The method of claim 33 wherein the coreactant further comprises a group selected from hydroxy group, isocyanate, or halide (e.g. chloride).
